(19) United States
(12) Patent Application Publication
(10) Pub. No.: US 2017/0134694 A1
(43) Pub. Date: May 11, 2017

(54) ELECTRONIC DEVICE FOR PERFORMING MOTION AND CONTROL METHOD THEREOF

(71) Applicant: Samsung Electronics Co., Ltd., Gyeonggi-do (KR)

(72) Inventors: Chi-Hyun CHO, Gyeonggi-do (KR); Dong-Il SON, Gyeonggi-do (KR); Chang-Ryong HEO, Gyeonggi-do (KR); Hee-Yeon JEONG, Seoul (KR); Jung-Su HA, Gyeonggi-do (KR); Mi-Jeong SONG, Gyeonggi-do (KR)

(73) Assignee: Samsung Electronics Co., Ltd.

(21) Appl. No.: 15/235,706

(22) Filed: Aug. 12, 2016

(30) Foreign Application Priority Data
Nov. 5, 2015 (KR) 10-2015-0155160

(51) Int. Cl. H04N 7/14; G05B 19/402; G06F 3/01; G06F 3/16; G06K 9/00

(52) U.S. Cl. CPC H04N 7/147; G06F 3/165; G06K 9/00342; G06F 3/017; G06K 9/00315; G05B 19/402; G05B 2219/35585; G05B 2219/43162

(57) ABSTRACT

An electronic device and a control method of the electronic device are provided. Voice data representing an external voice is acquired. A motion of a user of the electronic device is sensed. Motion data corresponding to the motion of the user is generated. The voice data is synchronized with the motion data in terms of time. The synchronized voice and motion data is transmitted to another electronic device.

### PRIORITY

This application claims priority under 35 U.S.C. §119(a) to Korean Application Serial No. 10-2015-0155160, which was filed in the Korean Intellectual Property Office on Nov. 5, 2015, the content of which is incorporated herein by reference.

### BACKGROUND

1. Field of the Disclosure

The present disclosure relates generally to an electronic device for performing a motion and a control method thereof, and more particularly, to an electronic device for performing a motion replicating a human behavior and a control method thereof.

2. Description of the Related Art

The demand for mobile communication devices (e.g., smart phones) having cameras has been steadily increasing. A conventional smart phone provides an image call function that transmits, to another electronic device, a voice of a user acquired through a microphone and an image of the user acquired through a camera. The user can confirm the appearance of the user of the other electronic device through a display of the smart phone by using the image call function, and the user of the other electronic device can also confirm the appearance of the user by using the image call function.

### SUMMARY

The present disclosure has been made to address at least the above problems and/or disadvantages and to provide at least the advantages described below. Accordingly, an aspect of the present disclosure provides an electronic device for replicating a human behavior by transmitting/receiving a behavior of a user during a telephone call and a control method thereof.

In accordance with an aspect of the present disclosure, an electronic device is provided that includes a microphone receiving an external voice and processing the external voice into voice data. The electronic device also includes a sensor sensing a motion of a user of the electronic device. The electronic device also includes a communication module forming a communication session with another electronic device. The electronic device further includes a processor that is electrically connected to the microphone, the communication module, and the sensor, and a memory that is electrically connected to the processor. The memory stores instructions that, when executed by the processor, cause the processor to generate motion data corresponding to the motion of the user, to synchronize the voice data with the motion data in terms of time, and to transmit the synchronized voice and motion data to the other electronic device through the communication session.

In accordance with another aspect of the present disclosure, a control method of an electronic device is provided. Voice data representing an external voice is acquired. A motion of a user of the electronic device is sensed. Motion data corresponding to the motion of the user is generated. The voice data is synchronized with the motion data in terms of time. The synchronized voice and motion data is transmitted to another electronic device.

### BRIEF DESCRIPTION OF THE DRAWINGS

The above and other aspects, features, and advantages of the present disclosure will be more apparent from the following detailed description when taken in conjunction with the accompanying drawings, in which:

FIG. 1A is a block diagram illustrating an electronic device and a network, according to an embodiment of the present disclosure;

FIG. 1B is a diagram illustrating an implementation, according to an embodiment of the present disclosure;

FIG. 2A is a block diagram illustrating a configuration of an electronic device, according to an embodiment of the present disclosure;

FIG. 2B is a block diagram illustrating a configuration of an electronic device, according to an embodiment of the present disclosure;

FIG. 3 is a block diagram illustrating a configuration of a program module, according to an embodiment of the present disclosure;

FIG. 4 is a block diagram illustrating software used by an electronic device, according to an embodiment of the present disclosure;

FIG. 5 is a diagram illustrating an operation of an electronic device, according to an embodiment of the present disclosure;

FIGS. 6A and 6B are diagrams illustrating an operation of an electronic device, according to an embodiment of the present disclosure;

FIGS. 7A and 7B are flow diagrams illustrating control methods of an electronic device, according to an embodiment of the present disclosure;

FIG. 7C is a diagram illustrating synthesized data, according to an embodiment of the present disclosure;

FIG. 8 is a signal flow diagram illustrating a control method of an electronic device, according to an embodiment of the present disclosure;

FIG. 9 is a diagram illustrating capability information, according to an embodiment of the present disclosure;

FIGS. 10A and 10B are diagrams illustrating an operation of an electronic device, according to an embodiment of the present disclosure;

FIG. 11 is a flowchart illustrating a control method of an electronic device, according to an embodiment of the present disclosure;

FIGS. 12A and 12B are diagrams illustrating the selection of a mode, according to an embodiment of the present disclosure;

FIGS. 13A and 13B are signal flow diagrams illustrating operation of an electronic device, according to an embodiment of the present disclosure;

FIGS. 14A and 14B are diagrams illustrating an operation of an electronic device, according to an embodiment of the present disclosure;

FIG. 14C is a diagram illustrating motion data, according to an embodiment of the present disclosure;

FIG. 15 is a flowchart illustrating a control method of an electronic device, according to an embodiment of the present disclosure;

FIG. 16 is flowchart illustrating a control method of an electronic device, according to an embodiment of the present disclosure;

FIG. 17 is a diagram illustrating association information between an event and motion data, according to an embodiment of the present disclosure;

FIGS. 18A and 18B are signal flow diagrams illustrating an operation of an electronic device, according to an embodiment of the present disclosure; and

FIG. 19 is a flowchart illustrating a control method of an electronic device, according to an embodiment of the present disclosure.

### DETAILED DESCRIPTION

Embodiments of the present disclosure are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure.

As used herein, the expressions “have,” “may have,” “include,” and “may include” refer to the existence of a corresponding feature (e.g., numeral, function, operation, or constituent element such as component), and do not exclude one or more additional features.

In the present disclosure, the expressions “A or B,” “at least one of A and B,” and “one or more of A and B” may include all possible combinations of the items listed. For example, the expressions refer to at least one A, at least one B, or at least one A and at least one B.

The expressions “a first,” “a second,” “the first,” and “the second”, as used herein, may modify various components regardless of the order and/or the importance but do not limit the corresponding components. For example, a first user device and a second user device indicate different user devices although both of them are user devices. Additionally, a first element may be referred to as a second element, and similarly, a second element may be referred to as a first element without departing from the scope of the present disclosure.

It should be understood that when an element (e.g., a first element) is referred to as being (operatively or communicatively) “connected,” or “coupled,” to another element (e.g., a second element), it may be directly connected or coupled directly to the other element or any other element (e.g., a third element) may be interposer between them. In contrast, it may be understood that when an element (e.g., the first element) is referred to as being “directly connected,” or “directly coupled” to another element (e.g., the second element), there is no element (e.g., the third element) interposed between them.

The expression “configured to”, as used herein, may be used interchangeably with, for example, “suitable for,” “having the capacity to,” “designed to,” “adapted to,” “made to,” or “capable of”, according to the situation. The term “configured to” may not necessarily imply “specifically designed to” in hardware. Alternatively, in some situations, the expression “device configured to” may mean that the device, together with other devices or components, “is able to.” For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments of the present disclosure and are not intended to limit the scope of other embodiments of the present disclosure. A singular expression may include a plural expression unless they are definitely different in context. Unless defined otherwise, all terms used herein, including technical and scientific terms, have the same meanings as those commonly understood by a person skilled in the art to which the present disclosure pertains. Such terms as those defined in a generally used dictionary may be interpreted to have the same meanings as the contextual meanings in the relevant field of the art, and are not to be interpreted to have ideal or excessively formal meanings unless clearly defined in the present disclosure. In some cases, even terms defined in the present disclosure should not be interpreted to exclude embodiments of the present disclosure.

An electronic device, according to embodiments of the present disclosure, may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a moving picture experts group (MPEG)-1 audio layer-3 (MP3) player, a mobile medical device, a camera, and a wearable device. According to embodiments of the present disclosure, the wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

According to embodiments of the present disclosure, the electronic device may be a home appliance. The home appliance may include at least one of, for example, a television, a digital versatile disc (DVD) player, an audio, a refrigerator, an air conditioner, a vacuum cleaner, an oven, a microwave oven, a washing machine, an air cleaner, a set-top box, a home automation control panel, a security control panel, a TV box, a game console, an electronic dictionary, an electronic key, a camcorder, and an electronic photo frame.

According to another embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment device, an electronic device for a ship (e.g., a navigation device for a ship, and a gyro-compass), avionics, security devices, an automotive head unit, a robot for home or industry, an automated teller machine (ATM) in banks, a point of sales (POS) terminal in a shop, or an Internet of Things (IoT) device (e.g., a light bulb, various sensors, electric or gas meter, a sprinkler device, a fire alarm, a thermostat, a streetlamp, a toaster, sporting goods, a hot water tank, a heater, a boiler, etc.).

According to embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, a radio wave meter, etc.). In embodiments of the present disclosure, the electronic device may be a combination of one or more of the above-described various devices. According to embodiments of the present disclosure, the electronic device may also be a flexible device. Further, the electronic device is not limited to the above-described devices, and may include a new electronic device according to the development of new technology.

Hereinafter, an electronic device, according to embodiments of the present disclosure will be described with reference to the accompanying drawings. In the present disclosure, the term “user” may indicate a person using an electronic device or a device (e.g., an artificial intelligence electronic device) using an electronic device.

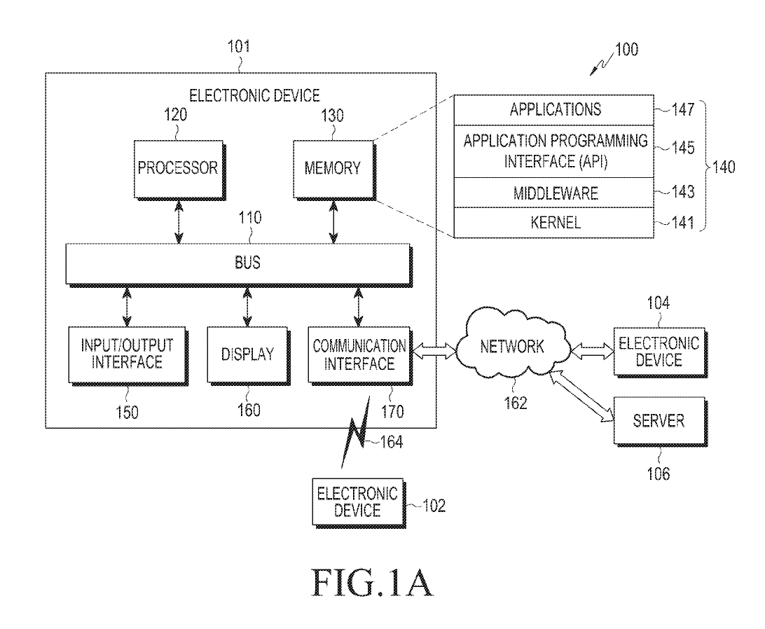

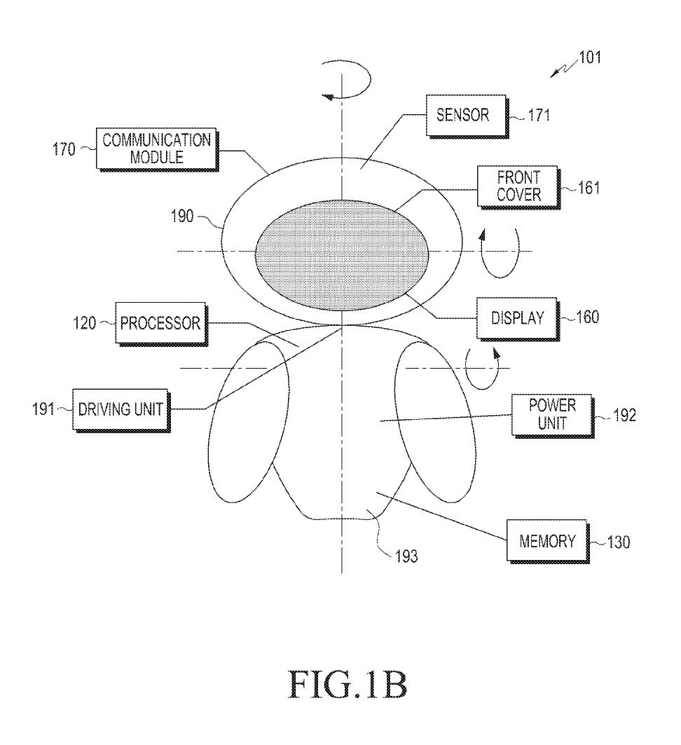

FIG. 1A is a diagram illustrating an electronic device in a network environment, according to an embodiment of the present disclosure. An electronic device 101 in a network environment 100 includes a bus 110, a processor 120, a memory 130, an input/output interface 150, a display 160, and a communication module 170. In some embodiments of the present disclosure, at least one of the above elements of the electronic device 101 may be omitted from the electronic device 101, or the electronic device 101 may include additional elements.

The bus 110 may include, for example, a circuit that interconnects the elements 110 to 170 and delivers a communication (e.g., a control message and/or data) between the elements 110 to 170.

The processor 120 may include one or more of a CPU, an AP, a communication processor (CP), a graphic processor (GP), a multi-chip package (MCP), and an image processor (IP). The processor 120 may perform, for example, calculations or data processing related to control over and/or communication by at least one of the other elements of the electronic device 101.

The memory 130 may include a volatile memory and/or a non-volatile memory. The memory 130 may store, for example, commands or data related to at least one of the other elements of the electronic device 101. According to an embodiment of the present disclosure, the memory 130 stores software and/or a program 140. The program 140 includes, for example, a kernel 141, middleware 143, an application programming interface (API) 145, and/or an application program (or an application) 147. At least some of the kernel 141, the middleware 143, and the API 145 may be referred to as an operating system (OS).

For example, the kernel 141 may control or manage system resources (e.g., the bus 110, the processor 120, the memory 130, and the like) used to execute operations or functions implemented by the other programs (e.g., the middleware 143, the API 145, and the application 147). Also, the kernel 141 may provide an interface capable of controlling or managing the system resources by accessing the individual elements of the electronic device 101 by using the middleware 143, the API 145, or the application 147.

For example, the middleware 143 may serve as an intermediary that enables the API 145 or the application 147 to communicate with the kernel 141 and to exchange data therewith.

Also, the middleware 143 may process one or more task requests received from the application 147 according to a priority. For example, the middleware 143 may assign a priority, which enables the use of system resources (e.g., the bus 110, the processor 120, the memory 130, etc.) of the electronic device 101, to at least one of the applications 147. For example, the middleware 143 may perform scheduling, load balancing, or the like of the one or more task requests by processing the one or more task requests according to the priority assigned to the at least one of the applications 147.

The API 145 is, for example, an interface through which the application 147 controls a function provided by the kernel 141 or the middleware 143, and may include, for example, at least one interface or function (e.g., command) for file control, window control, image processing, character control, or the like.

For example, the input/output interface 150 may serve as an interface capable of delivering a command or data, which is input from a user or another external device, to the element(s) other than the input/output interface 150 within the electronic device 101. Also, the input/output interface 150 may output, to the user or another external device, commands or data received from the element(s) other than the input/output interface 150 within the electronic device 101. The input/output interface 150 may include a touch input unit, a voice input unit, various remote control units, and the like. The input/output interface 150 may be at least one means for providing a particular service to a user. For example, the relevant input/output interface 150 may be a speaker when information required to be delivered is a sound, or may be a display apparatus when the information required to be delivered is text or image content. Also, data, which is required to output in order to provide a service in a situation where the user is not in proximity to the electronic device 101, may be delivered to at least another electronic device through the communication module so as to be capable of being output, and at this time, another electronic device may be a speaker or another display apparatus.

Examples of the display 160 may include a liquid crystal display (LCD), a light-emitting diode (LED) display, an organic-LED (OLED) display, a microelectromechanical systems (MEMS) display, and an electronic paper display. For example, the display 160 may display various pieces of content (e.g., text, images, videos, icons, symbols, etc.) to the user. The display 160 may include a touch screen, and may receive, for example, a touch input, a gesture input, a proximity input, or a hovering input provided by an electronic pen or a body part of the user.

The communication module 170 may establish, for example, communication between the electronic device 101 and an external device (e.g., a first external electronic device 102, a second external electronic device 104, or a server 106). For example, the communication module 170 may be connected to a network 162 through wireless or wired communication and may communicate with the external device (e.g., the second external electronic device 104 or the server 106). The communication module 170 is a means capable of transmitting/receiving at least one datum to/from another electronic device, and may communicate with another electronic device through at least one protocol.

The wireless communication may be performed by using at least one of, for example, long-term evolution (LTE), LTE-advanced (LTE-A), code division multiple access (CDMA), wideband CDMA (WCDMA), universal mobile telecommunications system (UMTS), wireless broadband (WiBro), and global system for mobile communications (GSM), as a cellular communication protocol. Also, examples of the wireless communication may include short-range communication 164. The short-range communication 164 may be performed by using at least one of, for example, Wi-Fi, Bluetooth, near filed communication (NFC), and global navigation satellite system (GNSS). The GNSS may include at least one of, for example, a global positioning system (GPS), a GNSS (Glonass), a Beidou navigation satellite system (Beidou), and a European global satellite-based navigation system (Galileo), according to a use area, a bandwidth, or the like. Hereinafter, in the present disclosure, the term “GPS” may be interchangeably used with the term “GNSS.” The wired communication may be performed by using at least one of, for example, a universal serial bus (USB), a high definition multimedia interface (HDMI), Recommended Standard 232 (RS-232), and a plain old telephone service (POTS). The network 162 may include at least one of communication networks, such as a computer network (e.g., a local area network (LAN), or a wide area network (WAN)), the Internet, and a telephone network.

Each of the first and second external electronic devices 102 and 104 may be of a type identical to or different from that of the electronic device 101. According to an embodiment of the present disclosure, the server 106 may include a group of one or more servers. According to embodiments of the present disclosure, all or some of operations performed by the electronic device 101 may be performed by another electronic device or multiple electronic devices (e.g., the first and second external electronic devices 102 and 104 or the server 106). When the electronic device 101 needs to perform some functions or services automatically or by request, the electronic device 101 may send, to another device (e.g., the first external electronic device 102, the second external electronic device 104, or the server 106), a request for performing at least some functions related to the functions or services, instead of performing the functions or services by itself. Another electronic device (e.g., the first external electronic device 102, the second external electronic device 104, or the server 106) may execute the requested functions or the additional functions, and may deliver a result of the execution to the electronic device 101. The electronic device 101 may process the received result without any change or additionally and may provide the requested functions or services. To this end, use may be made of, for example, cloud computing technology, distributed computing technology, or client-server computing technology.

FIG. 1B is a diagram illustrating an implementation, according to an embodiment of the present disclosure.

As illustrated in FIG. 1B, the electronic device 101 may be implemented in the form of a robot. The electronic device 101 includes a head portion 190 and a body portion 193. The head portion 190 may be disposed on an upper side of the body portion 193. In an embodiment of the present disclosure, the head portion 190 and the body portion 193 may be implemented in shapes respectively corresponding to a head and a body of a human being. For example, the head portion 190 includes a front cover 161 corresponding to the shape of the face of the human being. The electronic device 101 includes a display 160 disposed at a position corresponding to the front cover 161. For example, the display 160 may be disposed on an inside of the front cover 161, and in this case, the front cover 161 may be made of a transparent material or a semi-transparent material. Alternatively, the front cover 161 may be an element capable of displaying an optional screen, and in this case, the front cover 161 and the display 160 may be implemented by one piece of hardware. The front cover 161 is an element that indicates a direction in which an interaction with the user is performed, and may be one or more various sensors for sensing an image, one or more microphones for acquiring a voice, an apparatus-type eye structure, and a display for displaying a screen. In a form in which directions are not distinguished from each other, the front cover 161 may be displayed through light or a temporary apparatus change, and may include at least one piece of hardware or at least one apparatus-type structure that faces a direction in which the user is located when an interaction with the user is performed.

The head portion 190 further includes a communication module 170 and a sensor 171. The communication module 170 may receive a message from a transmission device, and may transmit a converted message to a reception device. The communication module 170 may be implemented as a microphone, and in this case, may receive a voice from the user. The communication module 170 may also be implemented as a speaker, and in this case, may output a converted message in a voice.

The sensor 171 may acquire at least one piece of information on an external environment. For example, the sensor 171 may be implemented as a camera, and in this case, may capture an image of the external environment. The electronic device 101 may identify a recipient according to a result of the image-capturing. The sensor 171 may sense the proximity of the recipient to the electronic device 101. The sensor 171 may sense the proximity of the recipient according to proximity information or based on a signal from an electronic device used by the recipient. Also, the sensor 171 may sense a behavior and a location of the user.

A driving unit 191 may include at least one motor that enables the head portion 190 to move, and may change, for example, a direction of the head portion 190. The driving unit 191 may be used to mechanically change a movement and other elements. Also, the driving unit 191 may have a form that enables an upward movement and a downward movement or a left movement and a right movement with at least one axis as a center, and the form may be variously implemented. A power unit 192 may supply power used by the electronic device 101.

The processor 120 may acquire a message from an originator through the communication module 170 or the sensor 171. The processor 120 may include at least one message analysis module. The at least one message analysis module may extract, from a message generated by the originator, or may classify main contents desired to be delivered to the recipient.

The memory 130 is a storage element capable of permanently or temporarily storing information related to providing a service to the user, and may exist in the electronic device, or may exist in a cloud server or another server through a network. The memory 130 may store personal information for user authentication, attribute-related information related to a scheme for providing a service to a user, or information which enables the recognition of a relationship between various means capable of interacting with the electronic device 101. The relationship information may be updated or learned and may be changed, according to the use of the electronic device 101. The processor 120 may take charge of controlling the electronic device 101, and may functionally control the sensor 171, the input/output interface 150, the communication module 170, and the memory 130 to provide a service to the user. Also, at least one part of the processor 120 or the memory 130 may include an information determination unit capable of determining information that the electronic device 101 may acquire. The information determination unit may extract at least one datum for a service, from information acquired through the sensor 171 or the communication module 170.

The implementation of the electronic device 101 in the form of a robot is only an example thereof, and an implementation form thereof is not limited. For example, the electronic device 101 may be implemented in a stand-alone type in which the electronic device 101 is formed as one entity corresponding to a robot. The electronic device 101 may be implemented in a docking station type in which a tablet PC or a smart phone is fixed. Alternatively, the electronic device 101 may belong to a fixed type or a mobile type according to whether the electronic device 101 has mobility, and examples of the mobile type may include a mobile type using wheels, a mobile type using a caterpillar, a mobile type using leg movement (including both two legs and four legs), and a mobile type using flying.

The electronic device 101 may further include a microphone that processes an external voice as voice data, and a sensor that senses a motion of a user. The communication module 170 may form a communication session with another electronic device. The memory 130 may store instructions that, when executed by the processor 120, cause the processor 120 to generate motion data corresponding to the sensed motion of the user, to synchronize the voice data with the motion data in terms of time, and to transmit the synchronized voice data and the synchronized motion data, i.e. synchronized voice and motion data to the another electronic device through the communication session.

The memory 130 may store instructions that, when executed by the processor 120, cause the processor 120 to generate synthesized data obtained by synthesizing the voice data and the motion data according to a preset protocol, and to transmit the synthesized data to the another electronic device through the communication session.

The motion data may include information for driving at least one motor included in the another electronic device. The motion data may include at least one of motor identification information, a driving time point, a driving direction, a driving degree, and a driving speed. The motion data may include a parameter corresponding to at least one of motor identification information, a driving time point, a driving direction, a driving degree, and a driving speed, and the another electronic device may drive the at least one motor included in the another electronic device by using the at least one of the motor identification information, the driving time point, the driving direction, the driving degree, and the driving speed which corresponds to the parameter.

In The memory 130 may store instructions that, when executed by the processor 120, cause the processor 120 to acquire capability information of the another electronic device, and to generate the motion data based on the capability information. The capability information may include at least one of physical information, a growth model, and a relationship model of the another electronic device.

The electronic device 101 may further include a camera. The memory 130 may store instructions that, when executed by the processor 120, cause the processor 120 to receive a signal corresponding to selection of whether an image call is performed or whether a motion call is performed. When the image call is selected, the processor synchronizes an image, which is output from the camera, with the voice data in terms of time, and transmits the synchronized image and the synchronized voice data to the other electronic device. When the motion call is selected, the processor synchronizes the motion data with the voice data in terms of time, and transmits the synchronized motion data and the synchronized voice data, i.e. synchronized voice and motion data to the other electronic device.

The electronic device 101 may further include at least one motor and a speaker. The memory 130 may store instructions that, when executed by the processor 120, cause the processor 120 to acquire motion data and voice data of the another electronic device from the another electronic device, to drive the at least one motor based on the motion data of the another electronic device, and to output the voice data of the another electronic device through the speaker.

The memory 130 may store association information between an event and motion data corresponding to the event, and may store an instruction that, when executed by the processor 120, causes the processor 120 to generate the motion data, which is obtained by reflecting the motion data corresponding to the event, if the processor 120 detects the event.

The memory 130 may store association information between a user and motion data corresponding to the user, and may store instructions that, when executed by the processor 120, cause the processor 120 to identify the user, and to generate the motion data which is obtained by reflecting the motion data corresponding to the identified user.

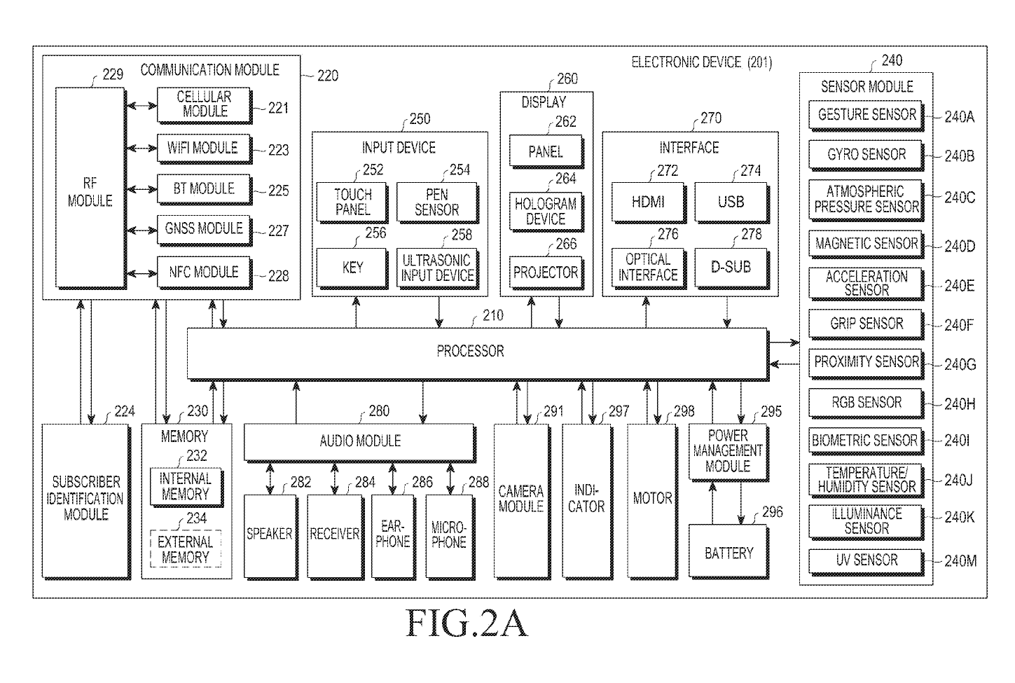

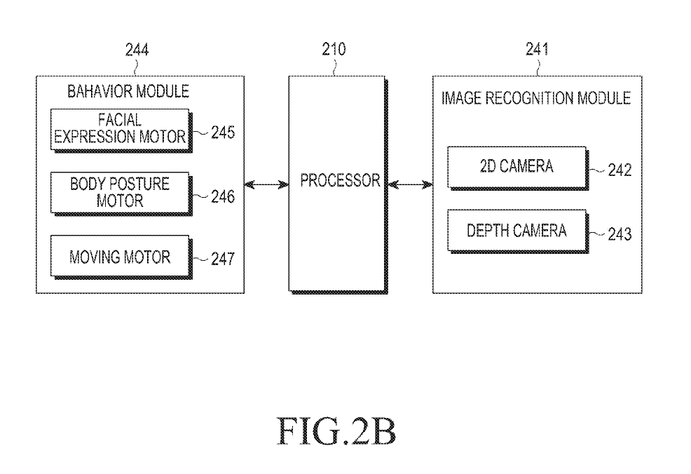

FIG. 2A is a block diagram illustrating a configuration of an electronic device, according to an embodiment of the present disclosure. For example, an electronic device 201 may include the whole or part of the electronic device 101 illustrated in FIG. 1A. The electronic device 201 includes at least one processor (e.g., an AP) 210, a communication module 220, a subscriber identification module (SIM) 224, a memory 230, a sensor module 240, an input apparatus 250, a display 260, an interface 270, an audio module 280, a camera module 291, a power management module 295, a battery 296, an indicator 297, and a motor 298.

The processor 210 may control multiple hardware or software elements connected to the processor 210 by running, for example, an OS or an application program, and may perform the processing of and arithmetic operations on various data. The processor 210 may be implemented by, for example, a system on chip (SoC). According to an embodiment of the present disclosure, the processor 210 may further include a graphical processing unit (GPU) and/or an image signal processor. The processor 210 may include at least some (e.g., a cellular module 221) of the elements illustrated in FIG. 2A. The processor 210 may load, into a volatile memory, instructions or data received from at least one (e.g., a non-volatile memory) of the other elements and may process the loaded instructions or data, and may store various data in a non-volatile memory.

The communication module 220 may have a configuration identical or similar to that of the communication interface 170 illustrated in FIG. 1A. The communication module 220 includes, for example, the cellular module 221, a Wi-Fi module 223, a Bluetooth (BT) module 225, a GNSS module 227 (e.g., a GPS module, a Glonass module, a Beidou module, or a Galileo module), an NFC module 228, and a radio frequency (RF) module 229.

For example, the cellular module 221 may provide a voice call, an image call, a text message service, an Internet service, and the like through a communication network. According to an embodiment of the present disclosure, the cellular module 221 may identify or authenticate an electronic device 201 in the communication network by using the SIM (e.g., a SIM card) 224. The cellular module 221 may perform at least some of the functions that the processor 210 may provide. The cellular module 221 may include a CP.

Each of the Wi-Fi module 223, the BT module 225, the GNSS module 227, and the NFC module 228 may include, for example, a processor for processing data transmitted and received through the relevant module. According to some embodiments of the present disclosure, at least some (e.g., two or more) of the cellular module 221, the Wi-Fi module 223, the BT module 225, the GNSS module 227, and the NFC module 228 may be included in one integrated circuit (IC) or IC package.

The RF module 229 may transmit and receive, for example, communication signals (e.g., RF signals). The RF module 229 may include, for example, a transceiver, a power amplifier module (PAM), a frequency filter, a low noise amplifier (LNA), and an antenna. According to another embodiment of the present disclosure, at least one of the cellular module 221, the Wi-Fi module 223, the BT module 225, the GNSS module 227, and the NFC module 228 may transmit and receive RF signals through a separate RF module.

The SIM 224 may include, for example, a card including a subscriber identity module and/or an embedded SIM, and may contain unique identification information (e.g., an integrated circuit card identifier (ICCID)) or subscriber information (e.g., an international mobile subscriber identity (IMSI)).

The memory 230 (e.g., the memory 130) may include, for example, an internal memory 232 or an external memory 234. The internal memory 232 may include at least one of, for example, a volatile memory (e.g., a dynamic random access memory (RAM) (DRAM), a static RAM (SRAM), a synchronous DRAM (SDRAM), etc.); a non-volatile memory (e.g., a one-time programmable read only memory (ROM) (OTPROM), a programmable ROM (PROM), an erasable and programmable ROM (EPROM), an electrically erasable and programmable ROM (EEPROM), a mask ROM, a flash ROM, a flash memory (e.g., a Not AND (NAND) flash memory, a Not OR (NOR) flash memory, etc.); a hard drive; and a solid state drive (SSD).

The external memory 234 may further include a flash drive, for example, a compact flash (CF), a secure digital (SD), a Micro-SD, a Mini-SD, an extreme digital (xD), a multi-media card (MMC), a memory stick, or the like. The external memory 234 may be functionally and/or physically connected to the electronic device 201 through various interfaces.

For example, the sensor module 240 may measure a physical quantity or may detect an operation state of the electronic device 201, and may convert the measured physical quantity or the detected operation state into an electrical signal. The sensor module 240 includes at least one of, for example, a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red-green-blue (RGB) sensor), a biometric sensor 240I, a temperature/humidity sensor 240J, an illuminance sensor 240K, and an ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 240 may further include a control circuit for controlling one or more sensors included therein. In some embodiments of the present disclosure, the electronic device 201 may further include a processor configured to control the sensor module 240 as a part of or separately from the processor 210, and may control the sensor module 240 while the processor 210 is in a sleep state.

The input apparatus 250 includes, for example, a touch panel 252, a (digital) pen sensor 254, a key 256, and an ultrasonic input unit 258. The touch panel 252 may use at least one of, for example, a capacitive scheme, a resistive scheme, an infrared scheme, and an acoustic wave scheme. Also, the touch panel 252 may further include a control circuit. The touch panel 252 may further include a tactile layer and may provide a tactile response to the user.

The (digital) pen sensor 254 may include, for example, a recognition sheet which is a part of the touch panel or is separated from the touch panel. The key 256 may be, for example, a physical button, an optical key, and a keypad. The ultrasonic input unit 258 may sense an ultrasonic wave generated by an input means through a microphone 288, and may confirm data corresponding to the sensed ultrasonic wave.

The display 260 (e.g., the display 160) includes a panel 262, a hologram unit 264, and a projector 266. The panel 262 may include a configuration identical or similar to that of the display 160 illustrated in FIG. 1A. The panel 262 may be implemented to be, for example, flexible, transparent, or wearable. The panel 262 and the touch panel 252 may be implemented as one module. The hologram unit 264 may display a three-dimensional image in the air by using the interference of light. The projector 266 may display an image by projecting light onto a screen. The screen may be located, for example, inside or outside the electronic device 201. According to an embodiment of the present disclosure, the display 260 may further include a control circuit for controlling the panel 262, the hologram unit 264, or the projector 266.

The interface 270 includes, for example, a HDMI 272, a USB) 274, an optical interface 276, and a D-subminiature (D-sub) 278. The interface 270 may be included in, for example, the communication interface 170 illustrated in FIG. 1A. Additionally or alternatively, the interface 270 may include, for example, a mobile high-definition link (MHL) interface, a SD card/multi-media card (MMC) interface, or an infrared data association (IrDA) standard interface.

For example, the audio module 280 may bidirectionally convert between a sound and an electrical signal. At least some elements of the audio module 280 may be included in, for example, the input/output interface 150 illustrated in FIG. 1A. The audio module 280 may process sound information which is input or output through, for example, a speaker 282, a receiver 284, an earphone 286, the microphone 288, or the like.

The camera module 291 is, for example, a device capable of capturing a still image and a moving image. According to an embodiment of the present disclosure, the camera module 291 may include one or more image sensors (e.g., a front sensor or a back sensor), a lens, an image signal processor (ISP), and a flash (e.g., an LED, a xenon lamp, or the like).

The power management module 295 may manage, for example, power of the electronic device 201. According to an embodiment of the present disclosure, the power management module 295 may include a power management integrated circuit (PMIC), a charger IC, or a battery gauge. The PMIC may use a wired and/or wireless charging method. Examples of the wireless charging method may include, for example, a magnetic resonance method, a magnetic induction method, an electromagnetic method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature during the charging. Examples of the battery 296 may include a rechargeable battery and a solar battery.

The indicator 297 may display a particular state (e.g., a booting state, a message state, a charging state, or the like) of the electronic device 201 or a part (e.g., the processor 210) of the electronic device 201. The motor 298 may convert an electrical signal into mechanical vibration, and may generate vibration, a haptic effect, or the like. The electronic device 201 may include a processing unit (e.g., a GPU) for supporting a mobile television (TV). The processing unit for supporting a mobile TV may process media data according to a standard, such as, for example, digital multimedia broadcasting (DMB) or digital video broadcasting (DVB).

Each of the elements set forth herein may be configured with one or more components, and the names of the corresponding elements may vary based on the type of electronic device. The electronic device may include at least one of the elements set forth herein. Some elements may be omitted or additional elements may be further included in the electronic device. Also, some of the hardware components may be combined into one entity, which may perform functions identical to those of the relevant components before the combination.

FIG. 2B is a block diagram illustrating a configuration of an electronic device, according to an embodiment of the present disclosure. As illustrated in FIG. 2B, the processor 120 is connected to an image recognition module 241. Also, the processor 120 is connected to a behavior module 244. The image recognition module 241 includes at least one of a two-dimensional (2D) camera 242 and a depth camera 243. The image recognition module 241 may perform recognition based on a result of the image-capturing, and may deliver a result of the recognition to the processor 210. The behavior module 244 includes at least one of a facial expression motor 245, a body posture motor 246, and a moving motor 247. The processor 210 may control the at least one of the facial expression motor 245, the body posture motor 246, and the moving motor 247, and thereby may control the motion of the electronic device 101 implemented in the form of a robot. The electronic device 101 may include the elements illustrated in FIG. 2B in addition to the elements illustrated in FIG. 2A.

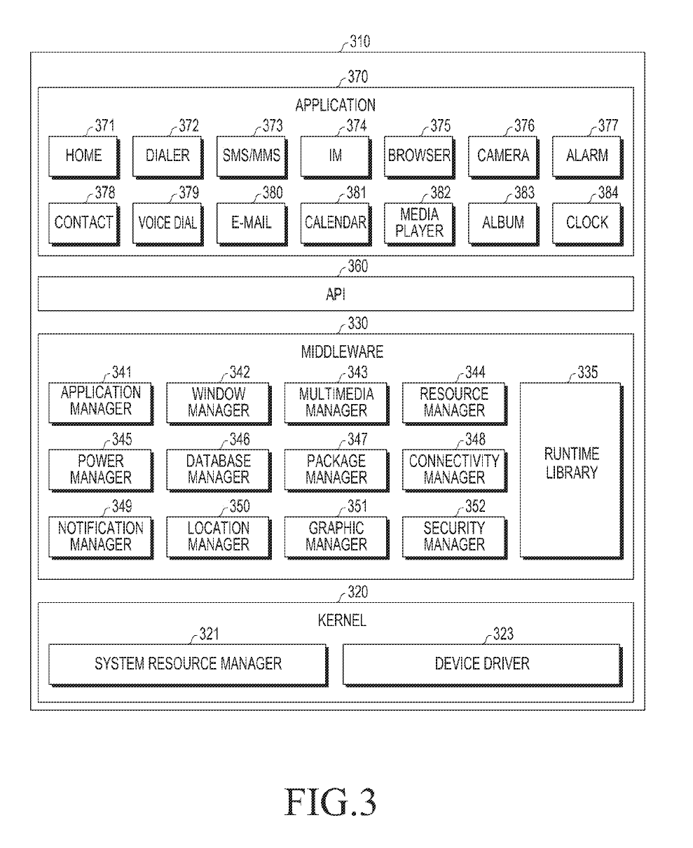

FIG. 3 is a block diagram illustrating a configuration of a program module, according to an embodiment of the present disclosure. A program module 310 (e.g., the program 140) may include an OS for controlling resources related to the electronic device (e.g., the electronic device 101) and/or various applications (e.g., the application programs 147) executed in the OS.

The program module 310 includes a kernel 320, middleware 330, an API 360, and/or an application 370. At least some of the program module 310 may be preloaded on the electronic device, or may be downloaded from an external electronic device (e.g., the first or second external electronic device 102 or 104, or the server 106).

The kernel 320 (e.g., the kernel 141) includes, for example, a system resource manager 321 and/or a device driver 323. The system resource manager 321 may perform the control, allocation, retrieval, or the like of system resources. According to an embodiment of the present disclosure, the system resource manager 321 may include a process manager, a memory manager, a file system manager, or the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

For example, the middleware 330 may provide a function required in common by the applications 370, or may provide various functions to the applications 370 through the API 360 so as to enable the applications 370 to efficiently use the limited system resources within the electronic device. According to an embodiment of the present disclosure, the middleware 330 (e.g., the middleware 143) includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a complier uses to add a new function by using a programming language during the execution of the application 370. The runtime library 335 may perform input/output management, memory management, the functionality for an arithmetic function, or the like.

The application manager 341 may manage, for example, the life cycle of at least one of the applications 370. The window manager 342 may manage graphical user interface (GUI) resources used for the screen. The multimedia manager 343 may determine a format required to reproduce various media files, and may encode or decode a media file by using a coder/decoder (codec) appropriate for the relevant format. The resource manager 344 may manage resources, such as a source code, a memory, a storage space, and the like of at least one of the applications 370.

For example, the power manager 345 may operate together with a basic input/output system (BIOS), etc. and may manage a battery or power, and may provide power information and the like required for an operation of the electronic device. The database manager 346 may generate, search for, and/or change a database to be used by at least one of the applications 370. The package manager 347 may manage the installation or update of an application distributed in the form of a package file.

The connectivity manager 348 may manage a wireless connection, such as, for example, Wi-Fi or Bluetooth. The notification manager 349 may display or notify of an event, such as an arrival message, an appointment, a proximity notification, and the like, in such a manner as not to disturb the user. The location manager 350 may manage location information of the electronic device. The graphic manager 351 may manage a graphic effect, which is to be provided to the user, or a user interface related to the graphic effect. The security manager 352 may provide various security functions required for system security, user authentication, and the like. According to an embodiment of the present disclosure, when the electronic device (e.g., the electronic device 101) has a telephone call function, the middleware 330 may further include a telephony manager for managing a voice call function or a video call function of the electronic device.

The middleware 330 may include a middleware module that forms a combination of various functions of the above-described elements. The middleware 330 may provide a module specialized for each type of OS in order to provide a differentiated function. Also, the middleware 330 may dynamically delete some of the existing elements, or may add new elements.

The API 360 (e.g., the API 145) is, for example, a set of API programming functions, and may be provided with a different configuration according to an OS. For example, in the one API set may be provided for each platform, two or more API sets may be provided for each platform.

The applications 370 (e.g., the application programs 147) includes one or more applications capable of performing functions, such as, for example, a home 371, a dialer 372, an SMS/MMS 373, an instant message (IM) 374, a browser 375, a camera 376, an alarm 377, a contact 378, a voice dialer 379, an email 380, a calendar 381, a media player 382, an album 383, a clock 384, health care (e.g., which measures an exercise quantity, a blood sugar level, or the like), and providing of environmental information (e.g., information on atmospheric pressure, humidity, temperature, or the like).

According to an embodiment of the present disclosure, the applications 370 may include an information exchange application supporting information exchange between the electronic device (e.g., the electronic device 101) and an external electronic device (e.g., the electronic device 102 or 104). Examples of the information exchange application may include a notification relay application for delivering particular information to an external electronic device and a device management application for managing an external electronic device.

For example, the notification relay application may include a function of delivering, to the external electronic device (e.g., the electronic device 102 or 104), notification information generated by other applications (e.g., an SMS/MMS application, an email application, a health care application, an environmental information application, etc.) of the electronic device 101. Also, for example, the notification relay application may receive notification information from the external electronic device and may provide the received notification information to the user.

The device management application may manage (e.g., install, delete, or update), for example, at least one function (e.g., turning on/off the external electronic device itself (or some component parts thereof) or adjusting the brightness (or resolution) of the display) of the external electronic device (e.g., the electronic device 102 or 104) communicating with the electronic device, an application executed in the external electronic device, or a service (e.g., a telephone call service, a message service, or the like) provided by the electronic device.

According to an embodiment of the present disclosure, the application 370 may include an application (e.g., a health care application of a mobile medical device or the like) designated according to an attribute of the external electronic device (e.g., the electronic device 102 or 104). The application 370 may include an application received from the external electronic device (e.g., the server 106, or the electronic device 102 or 104). The application 370 may include a preloaded application or a third party application which can be downloaded from the server. The names of the elements of the program module 310, according to the embodiment illustrated in FIG. 3, may vary according to the type of OS.

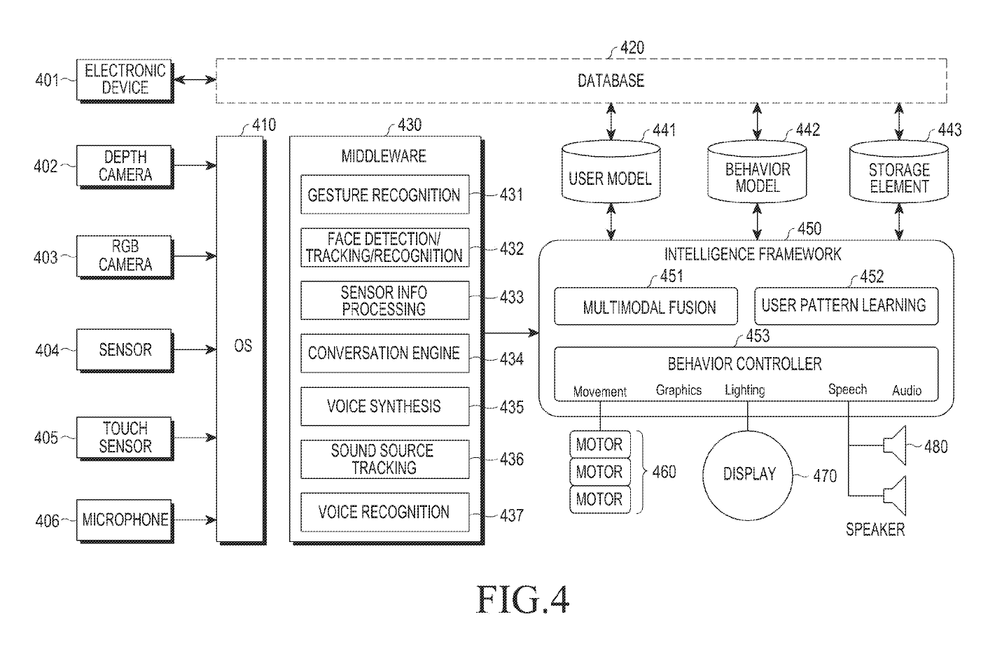

FIG. 4 is a block diagram illustrating software used by an electronic device, according to an embodiments of the present disclosure.

An OS 410 may perform operations of a typical OS, such as the allocation of resources, the processing of a job scheduling process, and the like of the electronic device 101, and simultaneously, may control various hardware apparatuses 402, 403, 404, 405, and 406 and may process signals received from the hardware apparatuses 402, 403, 404, 405, and 406.

By using signal-processed data, middleware 430 may recognize a three-dimensional (3D) gesture of the user (as indicated by reference numeral 431); may detect or track a location of the face of the user, or may perform authentication through face recognition (as indicated by reference numeral 432); may perform sensor information processing (as indicated by reference numeral 433); may drive a conversation engine (as indicated by reference numeral 434); may perform voice synthesis (as indicated by reference numeral 435); may perform the track of an input location (direction-of-arrival (DOA)) of an audio signal (as indicated by reference numeral 436); and may perform voice recognition (as indicated by reference numeral 437).

An intelligence framework 450 includes a multimodal fusion block 451, a user pattern learning block 452, and a behavior control block 453. The multimodal fusion block 451 may collect and manage various pieces of information processed by the middleware 430. The user pattern learning block 452 may extract and learn meaningful information, such as a living pattern, preference, and the like of the user, by using multimodal fusion module information. The behavior control block 453 may express information, that the electronic device 101 is to feed back to the user, as movement, graphics, lighting, voice, response, sound (speech and audio), and the like of the electronic device 101. A motor 460 may express a movement, a display 470 may express graphics and lighting, and a speaker 480 may express a voice, a response, and a sound.

A database 420 may store information, which has been learned by the intelligence framework 450, according to a user. The database 420 may include a user model database, a motion dada database for controlling a behavior of the electronic device, and a storage element that stores other information. Pieces of information within the database 420 may be shared with another electronic device 401.

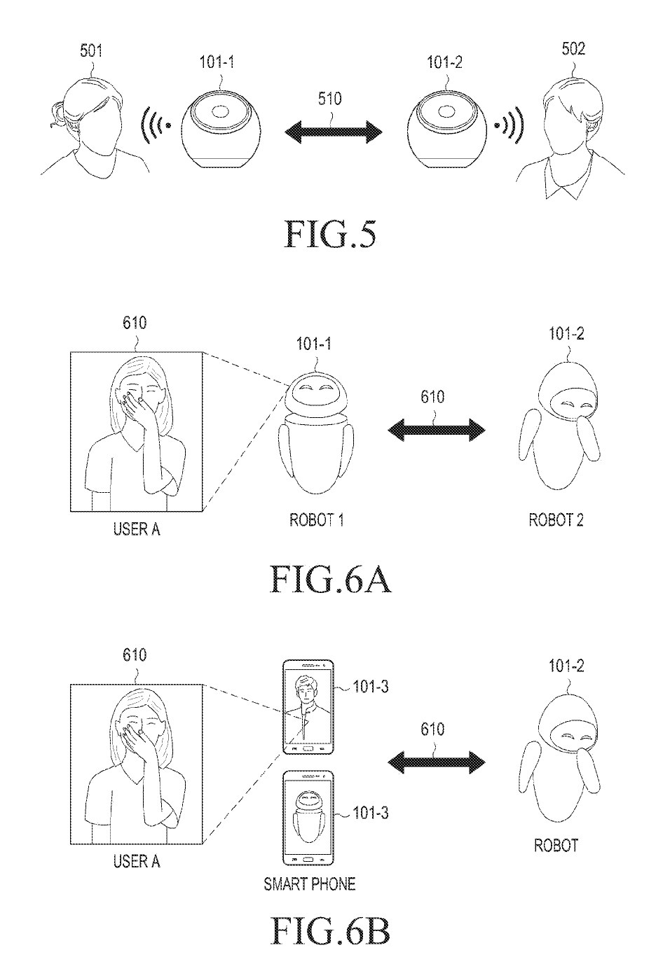

FIG. 5 is a diagram illustrating an operation of an electronic device, according to an embodiment of the present disclosure.

As illustrated in FIG. 5, a first electronic device 101-1 may capture an image of a first user 501 through a camera module and the like. The first electronic device 101-1 may also acquire a voice from the first user 501 through a microphone and the like. A second electronic device 101-2 may capture an image of a second user 502 through a camera module and the like. The second electronic device 101-2 may also acquire a voice from the second user 502 through a microphone and the like. The first electronic device 101-1 and the second electronic device 101-2 may form a communication session therebetween.

The first electronic device 101-1 transmits information 510, which includes images of moving images obtained by capturing images of the first user 501 and voice data acquired from the first user 501, to the second electronic device 101-2 through the communication session. The second electronic device 101-2 transmits information 510, which includes images of moving images obtained by capturing images of the second user 502 and voice data acquired from the second user 502, to the first electronic device 101-1 through the communication session. The first electronic device 101-1 may output voice data received from the second electronic device 101-2 while displaying an image received from the second electronic device 101-2. The second electronic device 101-2 may output voice data received from the first electronic device 101-1 while displaying an image received from the first electronic device 101-1. Accordingly, the first user 501 may hear the voice of the second user 502 while viewing the appearance of the second user 502, and thus can be provided with an image call function which allows the user to feel realistic.

FIGS. 6A and 6B are diagrams illustrating an operation of an electronic device, according to an embodiment of the present disclosure.

Referring to FIG. 6A, the first electronic device 101-1 captures an external image 610 through a camera module and the like. The first electronic device 101-1 may capture an image of an external environment at preset intervals from a time point at which a motion call begins, and accordingly, may acquire multiple images. Also, the first electronic device 101-1 may acquire an external voice through a microphone and the like.

The second electronic device 101-2 may capture an external image 620 through a camera module and the like. In various embodiments of the present disclosure, the second electronic device 101-2 may capture an image of an external environment at preset intervals from a time point at which a motion call begins, and accordingly, may acquire multiple images. Also, the second electronic device 101-2 may acquire an external voice through a microphone and the like.

The first electronic device 101-1 and the second electronic device 101-2 form a communication session therebetween. The communication session may be formed by a relay device (e.g., an access point (AP), a relay server, etc.) disposed between the first electronic device 101-1 and the second electronic device 101-2.

The first electronic device 101-1 may identify the user in each of the captured multiple images 610. For example, the first electronic device 101-1 may identify the user in each of the multiple images 610 by applying a person recognition algorithm to the multiple images 610. The first electronic device 101-1 may generate motion data on the basis of a difference between the multiple images 610.

The first electronic device 101-1 may include an infrared irradiation apparatus and an infrared sensor. The first electronic device 101-1 may irradiate infrared light, and may then sense reflected infrared light. The first electronic device 101-1 may measure a strength of the reflected infrared light or a change amount of the strength of the reflected infrared light, and may estimate a motion of the user by using the measured strength thereof or the measured change amount of the strength thereof.

The first electronic device 101-1 may estimate a motion of the user on the basis of a difference between the multiple images 610. The first electronic device 101-1 may generate motion data of an electronic device corresponding to the estimated motion of the user. For example, the first electronic device 101-1 may analyze the multiple images 610, and thereby may estimate a motion of the user expressing that the user, who exists outside of the first electronic device 101-1, puts the left hand over the mouth. In The first electronic device 101-1 may estimate a motion of the user by analyzing a change in the skeleton of a human body through the analysis of a 2D image. The first electronic device 101-1 may include a stereo camera, and may estimate a motion of the user on the basis of the recognition of a feature point recognized from the stereo camera and movement information of the feature point. The first electronic device 101-1 may include a dynamic vision sensor (DVS), and may estimate a motion of the user by using converted pixel information from among 2D data.

The first electronic device 101-1 may estimate a motion of the user by using an infrared sensor and a camera together. For example, the first electronic device 101-1 may include a structured light camera, and may estimate a motion of the user by analyzing a shift amount by using patterned infrared light. Alternatively, the first electronic device 101-1 may include a time-of-flight (TOF) camera, and may estimate a motion of the user by using a time period of flight of infrared light and a phase difference between reflected infrared rays.

According to an embodiment of the present disclosure, the first electronic device 101-1 may include an ultrasonic sensor, and may estimate a motion of the user by using measurement data from the ultrasonic sensor. The first electronic device 101-1 may detect a change in an RF signal around the first electronic device 101-1, and may estimate a motion of the user on the basis of the detected change in the RF signal. The first electronic device 101-1 may form an electric field, and may estimate a motion of the user by using a change of the formed electric field. In this case, there is no limit to the number and locations of electrodes for forming and detecting the electric field. The first electronic device 101-1 may sense a temperature difference between objects by using an infrared thermal camera, and may estimate a motion of the user by using the sensed temperature difference between the objects. The first electronic device 101-1 may acquire a motion of the user directly from information acquired by an apparatus, such as a kinetics TM, capable of sensing a motion of a user.

The first electronic device 101-1 may generate motion data of an electronic device corresponding to the estimated motion of the user. For example, the first electronic device 101-1 may generate motion data including a driving time point, a driving direction, a driving degree, and a driving speed of a motor capable of driving a right arm of the first electronic device 101-1. The motion data may be information that enables driving of the motor included in the electronic device, and a format of the motion data is not limited.

The first electronic device 101-1 may transmit, to the second electronic device 101-2, information 610 including the motion data and voice data. The information 610 may include the motion data and the voice data. For example, the first electronic device 101-1 may sequentially transmit the motion data and the voice data. Alternatively, the information 610 may be implemented in a format of synthesized data obtained by synthesizing the motion data and the voice data.

The second electronic device 101-2 may perform a motion by using the received information 610. The second electronic device 101-2 may receive the motion data, and may drive a motor based on the received motion data. Alternatively, the second electronic device 101-2 may acquire motion data by parsing the synthesized data which is the received information 610, and may drive the motor on the basis of the motion data obtained by parsing the synthesized data. For example, as illustrated in FIG. 6A, the second electronic device 101-2 may drive the motor on the basis of the motion data, and thereby may move a left arm of the second electronic device 101-2 to the vicinity of a relative lower side of a head portion. Accordingly, the second electronic device 101-2 may replicate the motion of the user of the first electronic device 101-1. Meanwhile, the second electronic device 101-2 may output the voice data. The voice data and the motion data may be synchronized and may be transmitted as the information 610, and accordingly, the second electronic device 101-2 may output the voice data while performing the motion. For example, when the user of the first electronic device 101-1 utters a voice saying “ha ha ha” while putting the left hand over the mouth, the first electronic device 101-1 may transmit information 610, which is obtained by synchronizing motion data for putting the left hand over the mouth with voice data corresponding to “ha ha ha,” to the second electronic device 101-2. The second electronic device 101-2 may output the voice data corresponding to “ha ha ha” at a time point of performing the motion data, and thereby may provide a motion call function which allows the user to feel realistic.

Meanwhile, the first electronic device 101-1 may receive, from the second electronic device 101-2, information including motion data and voice data. The first electronic device 101-1 may also output a voice while performing a motion on the basis of the received information, and thus, a bidirectional motion call function may be provided.

FIG. 6B is a diagram illustrating an operation of an electronic device, according to an embodiment of the present disclosure. Referring to FIG. 6B, in contrast with FIG. 6A, a third electronic device 101-3 does not include a motor for performing a motion. In this case, the third electronic device 101-3 may transmit, to the second electronic device 101-2, information 610 including motion data generated from captured images and voice data acquired through a microphone. The second electronic device 101-2 may transmit, to the third electronic device 101-3, information including motion data generated from captured images and voice data acquired through a microphone. The third electronic device 101-3 may change and display an action of an avatar by using the received information. The third electronic device 101-3 may display, on the display, an avatar corresponding to a user of the second electronic device 101-2. The third electronic device 101-3 may change and display the appearance of the avatar based on the motion data received from the second electronic device 101-2, and thereby may display that the avatar seems to move in response to the motion data from the second electronic device 101-2.

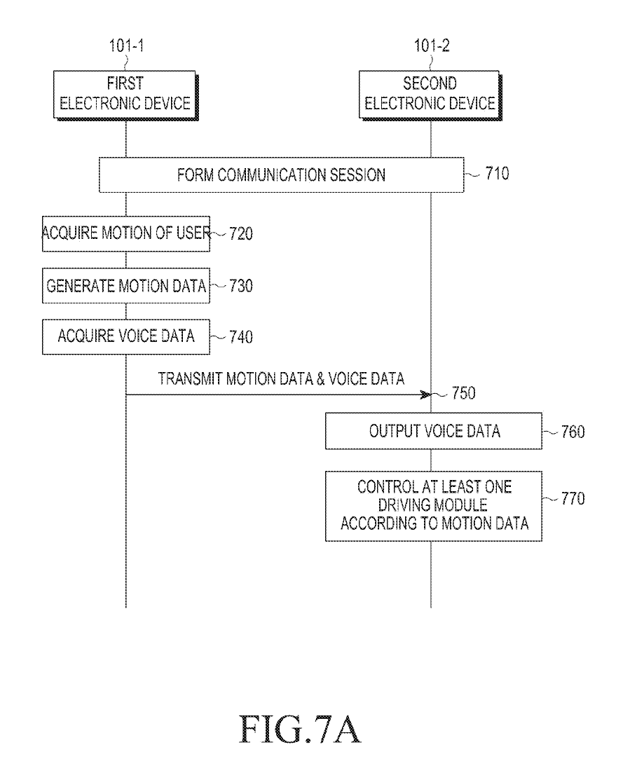

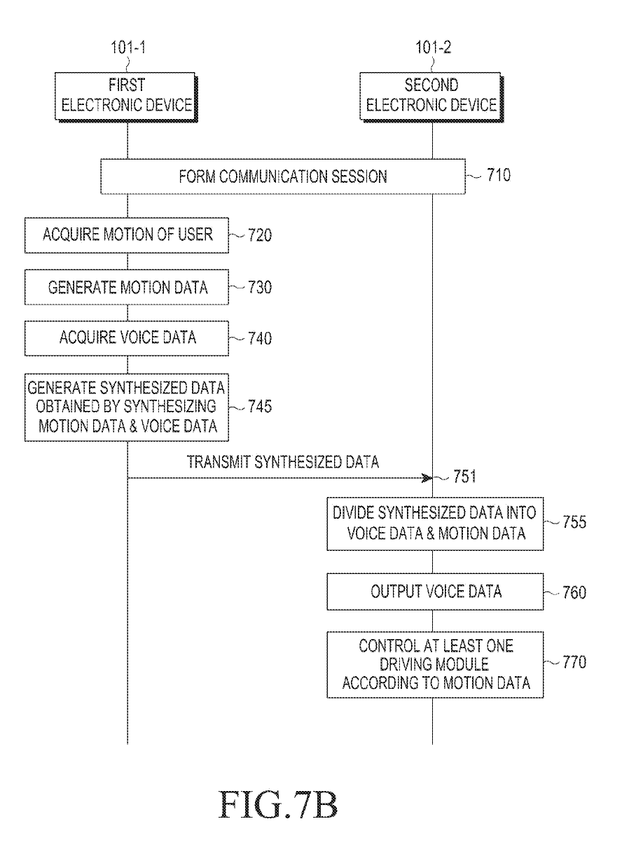

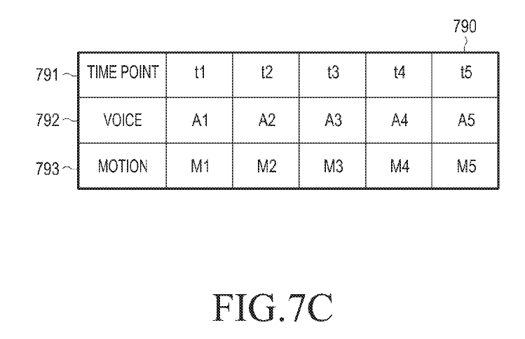

FIGS. 7A and 7B are signal flow diagrams illustrating a control method of an electronic device, according to an embodiment the present disclosure.

In step 710, the first electronic device 101-1 and the second electronic device 101-2 form a communication session therebetween. Each of the first electronic device 101-1 and the second electronic device 101-2 may execute an application for providing a motion call function. For example, the first electronic device 101-1 may send a telephone call request to the second electronic device 101-2, and a communication session may formed between the first electronic device 101-1 and the second electronic device 101-2 when the second electronic device 101-2 transmits a telephone call response to the received telephone call request. As illustrated in FIG. 7A, the first electronic device 101-1 and the second electronic device 101-2 are described as being directly forming a communication session therebetween, but this configuration is only an example thereof, and for example, various entities, such as a relay server and an AP, may form a communication session therebetween. More specifically, the first electronic device 101-1 may communicate with a neighboring first AP, the first AP may communicate with a relay server (e.g., a management server), the relay server may communicate with a second AP adjacent to the second electronic device 101-2, and the second AP may communicate with the second electronic device 101-2. In the present example, the execution of communication may refer to being capable of transmitting and receiving signals.

In step 720, the first electronic device 101-1 acquires a motion of a user. The first electronic device 101-1 may capture an image of an external environment. The first electronic device 101-1 may capture an image of the external environment at preset intervals, and accordingly, may acquire multiple images. The first electronic device 101-1 may acquire the motion of the user by analyzing the multiple images. More specifically, the first electronic device 101-1 may identify the user in each of multiple images of moving images. The first electronic device 101-1 may identify the user in each of the multiple images through a face recognition algorithm, a person recognition algorithm, or the like. The first electronic device 101-1 may determine a posture of the human body of the user in each of the multiple images by using a result of the recognition. A scheme for determining a posture of the human body of the user by the first electronic device 101-1 may use various techniques disclosed to the public, such as a skeleton analysis scheme, a mesh analysis scheme, and the like, and types of the techniques are not limited. The first electronic device 101-1 may acquire a depth image by using a depth camera at a time point of capturing an image, and may determine the posture of the human body of the user by additionally using the acquired depth image. The first electronic device 101-1 may determine a change in the posture of the human body of the user. For example, the first electronic device 101-1 may determine a change between a posture of the human body of the user at a first time point and a posture of the human body of the user at a second time point, and may determine a motion of the user by using the determined change. The first electronic device 101-1 may determine a motion of the user according to a position change of an object of an image. For example, the first electronic device 101-1 may compare the position of a first object (e.g., the hand of the user) in a first image with that of the first object in a second image without performing a modeling process, such as a skeleton, a mesh, or the like, and may determine the motion of the user on the basis of a position change of the identical object. Meanwhile, as described above, the first electronic device 101-1 may determine the motion of the user by using a conventional motion recognition sensor or based on a result of analyzing a depth image. Also, the motion of the user may be determined according to the above-described various schemes, and there is no limit to a determination process.

In step 730, the first electronic device 101-1 generates motion data. The first electronic device 101-1 may generate motion data based on the motion of the user. The motion data may be data that enables the first electronic device 101-1 or the second electronic device 101-2 to perform a motion. For example, the motion data may include at least one of a driving time point, a driving direction, a driving degree, and a driving speed of a motor included in the first electronic device 101-1 or the second electronic device 101-2. The first electronic device 101-1 may generate motion data by determining at least one of a driving time point, a driving direction, a driving degree, and a driving speed of a motor in response to the motion data. For example, consideration is given to a case where, through the analysis of the captured multiple images, the first electronic device 101-1 acquires a motion of the user expressing that the user lifts the left arm and puts the left hand over the mouth. The first electronic device 101-1 may generate, for example, the motion data shown in Table 1 below in response to the motion of the user.

TABLE 1

| Driving time point | Driving motor | Driving information |
|---|---|---|
| t1 | left shoulder motor | driving direction: A |
| | | driving degree: θ1 |
| | | driving speed: v1 |
| t2 | left shoulder motor | driving direction: A |
| | | driving degree: θ2 |
| | | driving speed: v2 |
| t3 | left elbow motor | driving direction: A |
| | | driving degree: θ3 |
| | | driving speed: v3 |
| t4 | left elbow motor | driving direction: A |
| | | driving degree: θ4 |
| | | driving speed: v4 |
| t5 | left elbow motor | driving direction: B |
| | | driving degree: θ5 |
| | | driving speed: v5 |
| t6 | left wrist motor | driving direction: A |
| | | driving degree: θ6 |
| | | driving speed: v6 |
| t7 | left wrist motor | driving direction: B |
| | | driving degree: θ7 |
| | | driving speed: v7 |

The first electronic device 101-1 may calculate motion data from a motion of the user. Alternatively, the first electronic device 101-1 may pre-store an association relationship between a motion of the user and motion data, and may select the motion data corresponding to the determined motion of the user. In this case, the first electronic device 101-1 may not transmit the motion data shown in Table 1, but may transmit, to the second electronic device 101-2, only information that enables the identification of motion data, such as an index, a parameter, or the like of the motion data. For example, the first electronic device 101-1 and the second electronic device 101-2 may pre-store the motion data shown in Table 1 in response to the parameter “putting the hand over the mouth.” The first electronic device 101-1 may transmit, to the second electronic device 101-2, motion data including the parameter “putting the hand over the mouth,” and the second electronic device 101-2 may drive the motor as shown in Table 1 in response to the parameter “putting the hand over the mouth.” Accordingly, the amount of data that the first electronic device 101-1 transmits to the second electronic device 101-2 may be reduced.

In step 740, the first electronic device 101-1 acquires voice data. In step 750, the first electronic device 101-1 transmits the motion data and the voice data to the second electronic device 101-2. The first electronic device 101-1 may synchronize the motion data with the voice data, and may transmit the synchronized motion data and the synchronized voice data, i.e. synchronized voice and motion data.

In step 760, the second electronic device 101-2 outputs a voice of the user. In step 770, the second electronic device 101-2 drives at least one driving module (e.g., a motor) according to the motion data. For example, the second electronic device 101-2 may drive the motor by using the motion data shown in Table 1. Accordingly, the second electronic device 101-2 may perform the motion of the user determined by the first electronic device 101-1. Therefore, the second electronic device 101-2 may drive the motor as in the case of replicating the motion of the user of the first electronic device 101-1.

As illustrated in FIG. 7A, the first electronic device 101-1 generates the motion data corresponding to the motion of the user. In other embodiments of the present disclosure, the first electronic device 101-1 may transmit a motion of the user to the second electronic device 101-2, and the second electronic device 101-2 may generate motion data corresponding to the motion of the user. In still another embodiment of the present disclosure, the first electronic device 101-1 may transmit multiple images to the second electronic device 101-2, the second electronic device 101-2 may determine a motion of the user on the basis of a result of analyzing the multiple images, and the second electronic device 101-2 may generate motion data by using the determined motion of the user.

As illustrated in FIG. 7A, a the first electronic device 101-1 determines a motion of the user by using a result of analyzing the multiple images and generates motion data based on the determined motion of the user, but the motion of the user may be for convenience of description. For example, the first electronic device 101-1 may immediately generate motion data by using the result of analyzing the multiple images.

The first electronic device 101-1 may acquire a facial expression of the user, which is obtained through the analysis of an image, as a motion of the user. The first electronic device 101-1 may transmit the motion of the user or motion data, which includes the facial expression of the user, to the second electronic device 101-2. The second electronic device 101-2 may drive a motor for implementing the facial expression of the user and may express the facial expression of the user, or may express an expression of the user by displaying a screen corresponding to the expression of the user on the display.

FIG. 7B is a signal flow diagram illustrating an operation of an electronic device, according to an embodiment of the present disclosure. A part of a description of FIG. 7B, which is repetitive of the description made with reference to FIG. 7A is omitted.

As described above, in steps 730 and 740, the first electronic device 101-1 acquires motion data and voice data. In step 745, the first electronic device 101-1 generates synthesized data obtained by synthesizing the motion data and the voice data. FIG. 7C shows synthesized data, according to an embodiment of the present disclosure. Referring to FIG. 7C, synthesized data 790 includes voice data 792 and motion data 793 for each driving time point 791. The first electronic device 101-1 may generate the synthesized data 790 by synchronizing the voice data 792 with the motion data 793.

Referring back to FIG. 7B, in step 751, the first electronic device 101-1 transmits the synthesized data to the second electronic device 101-2. In step 755, the second electronic device 101-2 acquires voice data and motion data by parsing the synthesized data. Accordingly, in steps 760 and 770, the second electronic device 101-2 outputs the voice data, and drives at least one driving module (e.g., a motor) by using the motion data.

As described above, the electronic device, according to various embodiments of the present disclosure, may not transmit voice data and motion data, but may generate and transmit synthesized data in a particular data format.

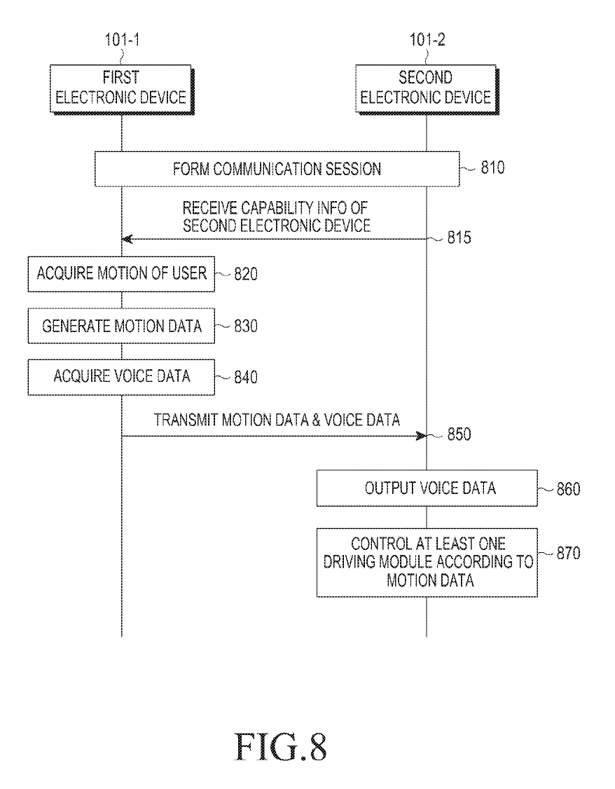

FIG. 8 is a signal flow diagram illustrating a control method of an electronic device, according to an embodiment of the present disclosure.

In step 810, the first electronic device 101-1 and the second electronic device 101-2 form a communication session therebetween.

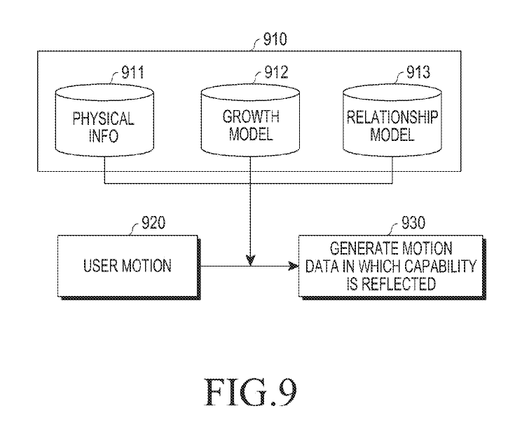

In step 815, the first electronic device 101-1 receives capability information of the second electronic device 101-2. FIG. 9 is a diagram illustrating capability information, according to an embodiment of the present disclosure. The capability information 910 includes at least one of physical information 911, a growth model 912, and a relationship model 913. The physical information 911 may be information on hardware and the like included in the electronic device. For example, the physical information 911 may include information on whether the electronic device belongs to a fixed type or a mobile type, whether a facial expression of the user is displayed on the display and is expressed by a combination of motors, whether a head belongs to a type which enables the head to turn up and down, and right and left, whether the electronic device has arms, what is the number of joints of an arm when the arm is capable of being moved, whether fingers are capable of being controlled, whether a waist is capable of being turned, whether a back is capable of being bent, and the like. The physical information 911 may include information on whether the electronic device moves with wheels, whether the electronic device moves with legs, whether a leg has joints, whether the electronic device has wings, and the like.

The growth model 912 may represent whether hardware is available according to the growth degree of the electronic device. The electronic device according to various embodiments of the present disclosure may limit some of hardware functions of the hardware according to the growth model 912. For example, when an age according to the growth model 912 corresponds to an initial stage, the electronic device may limit multiple functions among the hardware functions, and may cancel the restriction of the limited hardware functions as the age increases. Accordingly, the electronic device may produce an effect in a case where motion execution capability evolves. For example, at a time point of the relatively low age, the electronic device may limit the functions of the hardware that drives joints of the fingers, and accordingly, may limit the functions of the hardware so as not to express a heart gesture with the fingers. As the age increases, the electronic device may perform a control operation for canceling the restriction of the functions of the hardware that drives the joints of the fingers and expressing the heart gesture with the fingers.

The relationship model 913 may be hardware control information which reflects a relationship between the electronic device and the user. The electronic device may pre-store a gesture or a facial expression that the electronic device has often used during an interaction with a particular user, and may store the gesture or the facial expression as the relationship model 913.

As described above, the first electronic device 101-1 may receive various pieces of capability information of the second electronic device 101-2. As illustrated in FIG. 8, the first electronic device 101-1 receives capability information directly from the second electronic device 101-2. In other embodiments of the present disclosure, the first electronic device 101-1 may receive capability information of the second electronic device 101-2 from a server. Alternatively, the first electronic device 101-1 may pre-store capability information for each electronic device, and may determine capability information of the second electronic device 101-2 corresponding to the identification information of the second electronic device 101-2 acquired in a communication session formation process and the like.

Referring back to FIG. 8, in step 820, the first electronic device 101-1 acquires a motion of the user. As described above, the first electronic device 101-1 may acquire the motion of the user by using a result of analyzing the captured multiple images.

In step 830, the first electronic device 101-1 generates motion data on the basis of the motion of the user and the capability information of the second electronic device 101-2. For example, the first electronic device 101-1 may generate the motion data shown in Table 2 below corresponding to a motion of the user. Meanwhile, the first electronic device 101-1 may acquire capability information indicating that the second electronic device 101-2 includes a “left elbow motor” and a “left shoulder motor.” Specifically, the first electronic device 101-1 may acquire capability information of the second electronic device 101-2 indicating that the second electronic device 101-2 does not include a “left wrist motor.” Accordingly, the first electronic device 101-1 may modify the motion data shown in Table 1 as shown in Table 2 below.

TABLE 2

| Driving time point | Driving motor | Driving information |
|---|---|---|
| t1 | left shoulder motor | driving direction: A |
| | | driving degree: θ1 |
| | | driving speed: v1 |
| t2 | left shoulder motor | driving direction: A |
| | | driving degree: θ2 |
| | | driving speed: v2 |
| t3 | left elbow motor | driving direction: A |
| | | driving degree: θ3 |
| | | driving speed: v3 |
| t4 | left elbow motor | driving direction: A |
| | | driving degree: θ4 |
| | | driving speed: v4 |
| t5 | left elbow motor | driving direction: B |
| | | driving degree: θ5 |
| | | driving speed: v5 |
| t6 | driving information does | driving information does |
| | not exist | not exist |
| t7 | driving information does | driving information does |
| | not exist | not exist |

The first electronic device 101-1 may delete driving information, which corresponds to each of driving time points t6 and t7, in response to a configuration indicating that a left wrist motor is not included in the second electronic device 101-2 which is set at the driving time points t6 and t7. Specifically, the first electronic device 101-1 may generate motion data on the basis of physical information of the second electronic device 101-2. In various embodiments of the present disclosure, the first electronic device 101-1 may generate motion data on the basis of a growth model or a relationship model of the second electronic device 101-2. For example, the first electronic device 101-1 may generate the motion data shown in Table 2 by limiting the driving of the left wrist motor, of which the execution is limited at a low age, on the basis of information indicating that the age is low according to the growth model of the second electronic device 101-2. Alternatively, the first electronic device 101-1 may generate motion data by adding an additional action to the motion data shown in Table 1 on the basis of the relationship model between the second electronic device 101-2 and the user. As described above, as illustrated in FIG. 9, the first electronic device 101-1 may generate motion data 930 by using a user motion 920 of the user as capability information 910.

In step 840, the first electronic device 101-1 generates voice data. In step 850, the first electronic device 101-1 transmits the motion data and the voice data to the second electronic device 101-2.

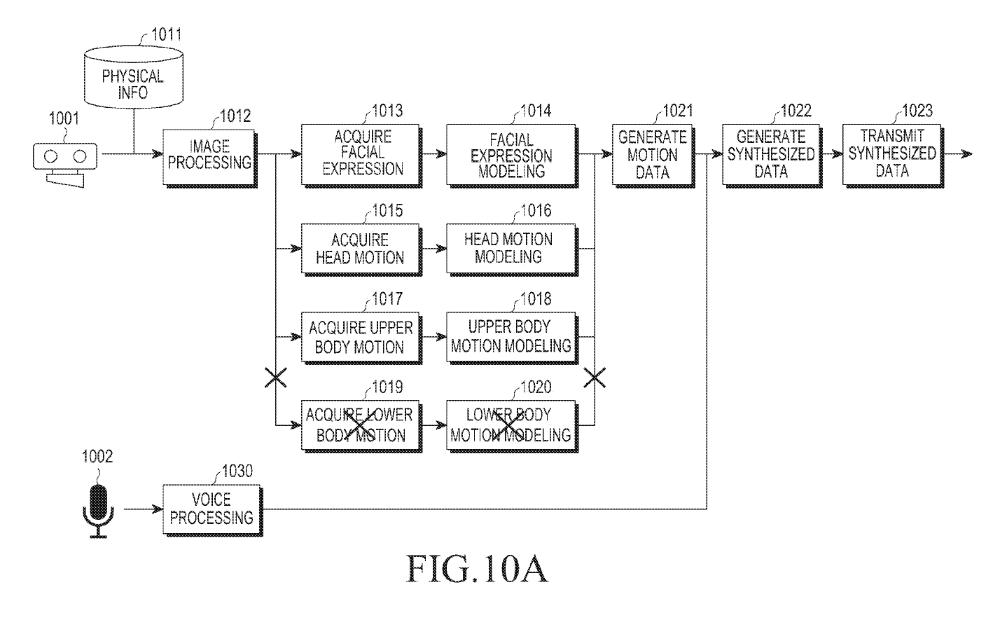

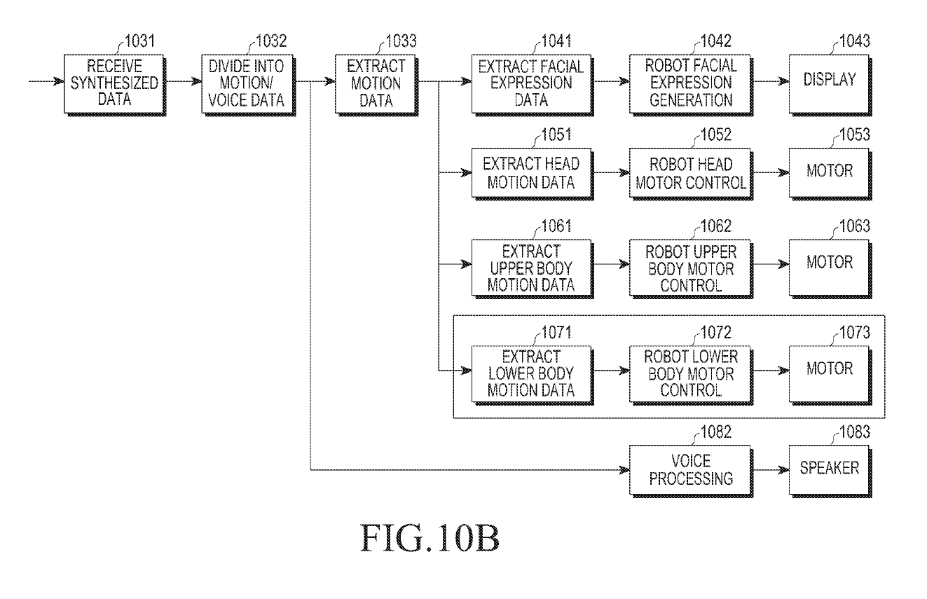

In step 860, the second electronic device 101-2 outputs the voice data. In step 870, the second electronic device 101-2 controls at least one driving module, for example, a motor, according to the motion data. Since the second electronic device 101-2 has received, for example, the motion data shown in Table 2, the second electronic device 101-2 may drive the motor according to the motion data although the second electronic device 101-2 does not include the left wrist motor. The second electronic device 101-2 may receive motion data in which capability information is not reflected, and may modify the motion data on the basis of the capability information that is set for the second electronic device 101-2, and may perform a motion. This configuration is described in greater detail below with reference to FIGS. 10A and 10B.

FIGS. 10A and 10B are diagrams illustrating an operation of an electronic device, according to an embodiment of the present disclosure.

Referring to FIG. 10A, the first electronic device 101-1 performs image processing on an image provided by a sensor 1001, in step 1012. The first electronic device 101-1 acquires a facial expression, in step 1013, a head motion, in step 1015, an upper body motion, in step 1017, and a lower body motion, in step 1019, based on a result of the image processing in step 1012. The first electronic device 101-1 performs facial expression modeling, in step 1014, head motion modeling, in step 1016, upper body motion modeling, in step 1018, and lower body motion modeling, in step 1020. The modeling is a process for generating motion data, and may be the generation of driving information of a motor. The first electronic device 101-1 may acquire physical information 1011 indicating that the second electronic device 101-2 does not include a lower body driving motor. Accordingly, the first electronic device 101-1 may not perform a process for the acquisition of the lower body motion, in step 1019, and the lower body motion modeling, in step 1020. The first electronic device 101-1 may generate motion data 1021 that does not include the lower body-related information. The first electronic device 101-1 performs voice processing on voice data acquired through a microphone 1002, in step 1030, and generates synthesized data obtained by synthesizing the motion data and the voice data, in step 1022. The first electronic device 101-1 transmits the synthesized data, in step 1023.

FIG. 10B is a diagram illustrating a process for modifying motion data by a reception-side electronic device. The second electronic device 101-2 receives the synthesized data, in step 1031. Consideration is given to a case where the synthesized data includes motion data including even lower body-related data. The second electronic device 101-2 divides the received synthesized data, in step 1032. The second electronic device 101-2 extracts motion data, in step 1033. The second electronic device 101-2 extracts facial expression data, in step 1041, head motion data, in step 1051, upper body motion data, in step 1061, and lower body motion data, in step 1071. The second electronic device 101-2 generates data for each of robot facial expression generation, in step 1042, robot head motor control, in step 1052, robot upper body motor control, in step 1062, and robot lower body motor control, in step 1072. The second electronic device 101-2 drives a display 1043 and motors 1053, 1063, and 1073 by using the generated data. The second electronic device 101-2 may not extract the lower body motion data, in step 1071, by using capability information of the second electronic device 101-2, and may not perform a subsequent operation by using the capability information thereof. The second electronic device 101-2 processes voice data, in step 1081, and outputs the processed voice data through a speaker 1083, in step 1082.

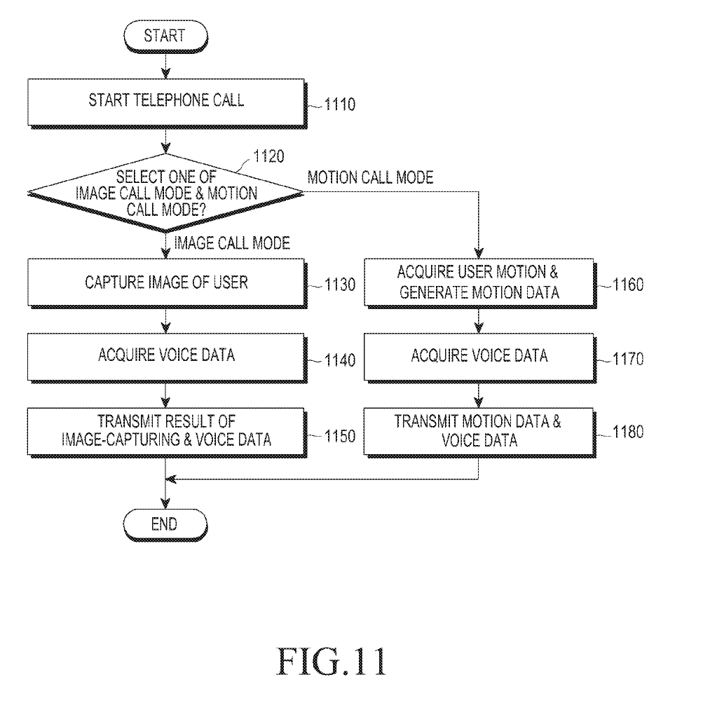

FIG. 11 is a flowchart illustrating a control method of an electronic device, according to an embodiment of the present disclosure.

In step 1110, the electronic device 101-1 starts a telephone call. In step 1120, the electronic device 101-1 selects one of an image call mode and a motion call mode. The electronic device 101-1 may select one of the two modes according to a user input or according to whether an execution condition for each of the image call mode and the motion call mode has been detected.

When the image call mode has been selected, in step 1130, the electronic device 101-1 captures an image of an appearance including a user. In step 1140, the electronic device 101-1 acquires voice data. In step 1150, the electronic device 101-1 transmits a result of the image-capturing and the voice data. A reception-side electronic device may output the voice data while displaying the result of the image-capturing, and thereby, the image call may be performed.

When the motion call mode has been selected, in step 1160, the electronic device 101-1 acquires a user motion of the user, and may generate motion data. In step 1170, the electronic device 101-1 acquires voice data. In step 1180, the electronic device 101-1 transmits the motion data and the voice data. The reception-side electronic device may output the voice data while performing a motion according to the motion data, and thereby, the motion call may be performed.

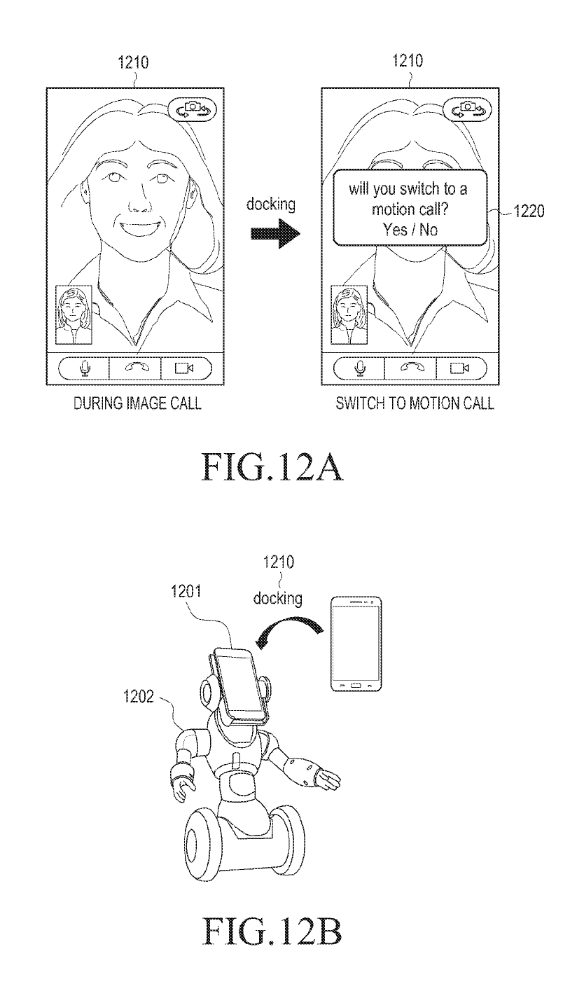

FIGS. 12A and 12B are conceptual views for explaining the selection of a mode, according to an embodiment of the present disclosure.

FIG. 12A is a diagram illustrating a graphical user interface displayed by the electronic device, according to an embodiment of the present disclosure. As illustrated in FIG. 12A, the electronic device 101 display a screen 1210 corresponding to an image call. Meanwhile, the electronic device 101 displays a graphical user interface 1220 that enables switching to a motion call, on a screen 1210. When the electronic device 101 detects an input for switching to the motion call, the electronic device 101 may switch a mode thereof to a motion call mode, and may transmit motion data.

FIG. 12B is a diagram illustrating mode switching, according to an embodiment of the present disclosure. Referring to FIG. 12B, an electronic device 1201 may be docked (as indicated by reference numeral 1210) to a robot 1202. In the present example, the robot 1202 may refer to an electronic device having a motor capable of performing a motion. The electronic device 1201 may be docked to the robot 1202 and may be physically connected to the robot 1202, and thus may move together with the robot 1202 and may transmit/receive data to/from the robot 1202. Specifically, motion data received by the electronic device 1201 may be output to the robot 1202, and the robot 1202 may perform a motion corresponding to the motion data. When the electronic device 1201 is docked (as indicated by reference numeral 1210) to the robot 1202, the electronic device 1201 may perform mode switching from the image call mode to the motion call mode. The electronic device 1201 may perform mode switching from the image call mode to the motion call mode on the basis of information indicating that a reception-side electronic device has been docked.

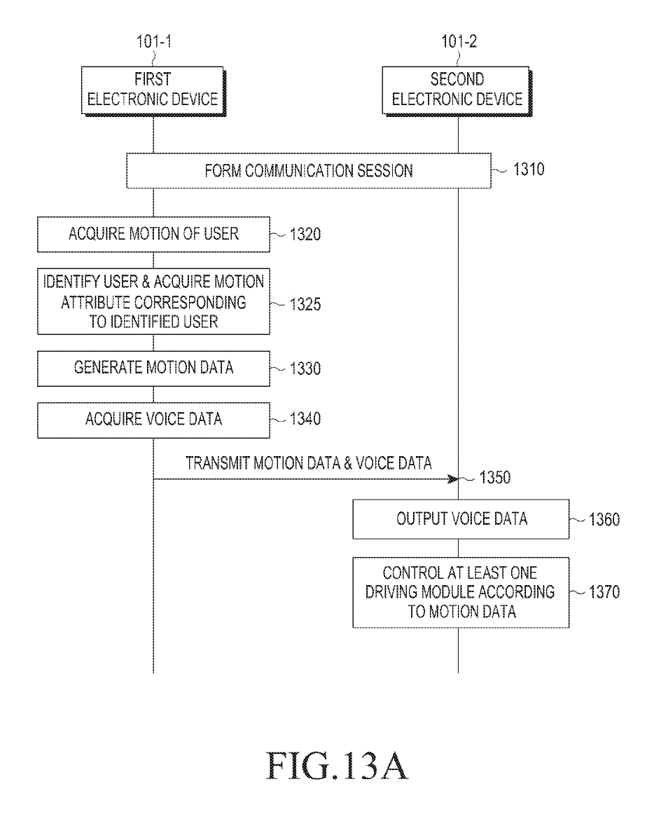

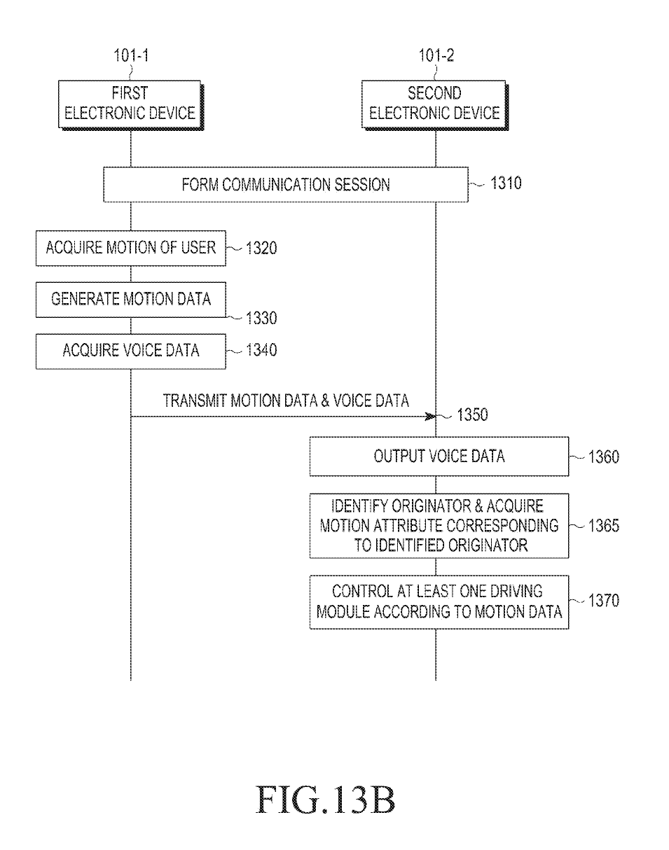

FIGS. 13A and 13B are signal flow diagrams illustrating an operation of an electronic device, according to an embodiment of the present disclosure.

Referring to FIG. 13A, in step 1310, the first electronic device 101-1 and the second electronic device 101-2 form a communication session therebetween. In step 1320, the first electronic device 101-1 acquires a motion of a user. These operations have been described in detail above, and thus, a detailed description thereof is omitted.

In step 1325, the first electronic device 101-1 identifies a user who uses the first electronic device 101-1, and acquires a motion attribute of the motion corresponding to the identified user. For example, the first electronic device 101-1 may analyze a captured image, and may identify a person in the image by using a result of the analysis. Alternatively, the first electronic device 101-1 may identify the user on the basis of preset user information. The motion attribute may refer to a user motion or motion data which is set for each user. For example, the first electronic device 101-1 may pre-store the motion attributes shown in Table 3 below.

TABLE 3

| User | Motion attribute |
|---|---|
| James | motion attribute of touching the head |
| Ted | motion attribute of covering the mouth |

As described above, the first electronic device 101-1 may store a motion attribute including a user motion for each user. In another embodiment of the present disclosure, the first electronic device 101-1 may store motion data (i.e., driving information of a motor) for each user.

In step 1330, the first electronic device 101-1 generates motion data on the basis of the user motion and the motion attribute. The first electronic device 101-1 generates first motion data based on the user motion, and may then generate motion data by reflecting second motion data according to the motion attribute in the first motion data.

In step 1340, the first electronic device 101-1 acquires voice data. In step 1350, the first electronic device 101-1 transmits the motion data and the voice data to the second electronic device 101-2. The first electronic device 101-1 may separately transmit the motion data and the voice data to the second electronic device 101-2, or may transmit synthesized data, which is obtained by synthesizing the motion data and the voice data, to the second electronic device 101-2.

In step 1360, the second electronic device 101-2 outputs the voice data. In step 1370, the second electronic device 101-2 controls at least one driving module (e.g., a motor) according to the motion data. Since a motion attribute for each user is reflected, the second electronic device 101-2 may replicate a motion which is more similar to that of the user of the first electronic device 101-1.

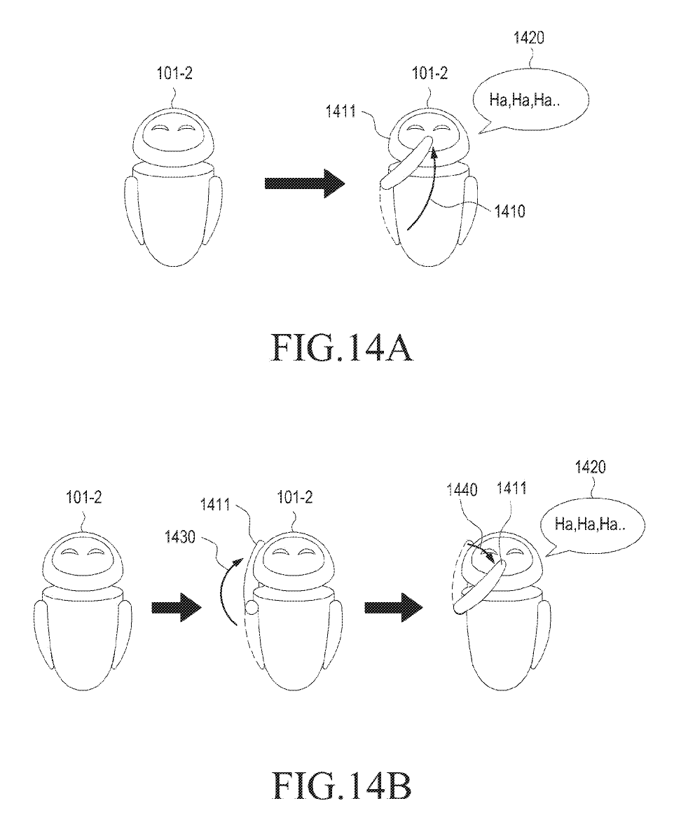

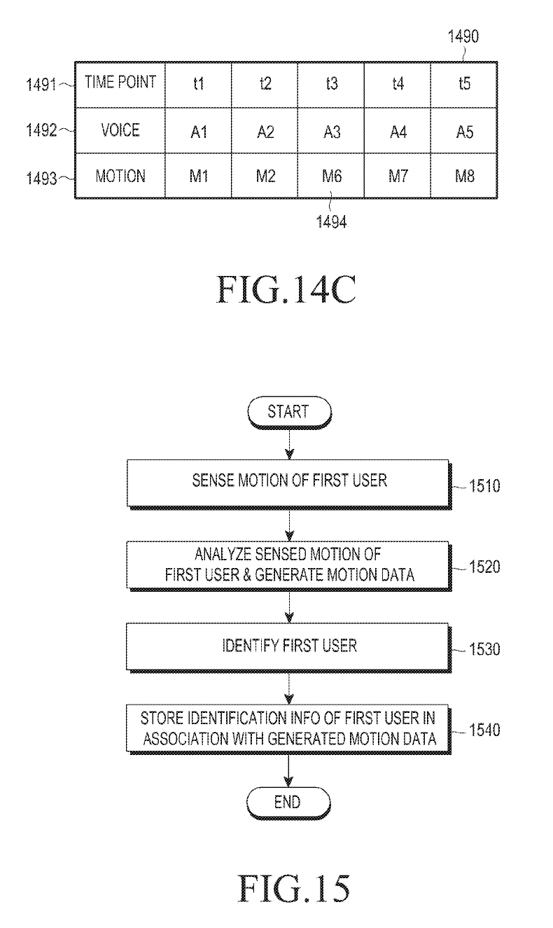

FIG. 13B is a signal flow diagram illustrating an operation of an electronic device, according to according to another embodiment of the present disclosure. The operation of the electronic device illustrated in FIG. 13B is described with reference to FIGS. 14A to 14C. FIGS. 14A and 14B are diagrams illustrating an operation of an electronic device, according to an embodiment of the present disclosure. FIG. 14C is a diagram illustrating motion data, according to an embodiment of the present disclosure.

Referring to FIG. 13B, in step 1310, the first electronic device 101-1 forms a communication session with the second electronic device 101-2. In step 1320, the first electronic device 101-1 acquires a motion of a user. In step 1330, the first electronic device 101-1 generates motion data. In step 1340, the first electronic device 101-1 acquires voice data. In step 1350, the first electronic device 101-1 transmits the motion data and the voice data to the second electronic device 101-2.

In step 1360, the second electronic device 101-2 outputs the voice data. In step 1365, the second electronic device 101-2 identifies an originator (i.e., the user of the first electronic device 101-1), and acquires a motion attribute corresponding to the identified originator. For example, the second electronic device 101-2 may pre-store the motion attributes shown in Table 3. The second electronic device 101-2 may identify that the originator is James, and may reflect the motion of touching the head, which corresponds to the motion attribute of James, in the received motion data in response to a result of the identification. In step 1370, the second electronic device 101-2 controls at least one driving module (e.g., a motor) according to the motion data. Accordingly, the second electronic device 101-2 may perform the motion of touching the head that James often makes, in addition to a motion according to the received motion data.

For example, as illustrated in FIG. 14A, the second electronic device 101-2 outputs voice data 1420 together with a motion 1410 of moving a right arm 1411 to a lower part of a head portion according to the received motion data. As illustrated in FIG. 14B, the second electronic device 101-2 reflects the motion attribute of the originator in the received motion data, performs a motion 1430 of moving the right arm 1411 to an upper part of the head portion, and then performs a motion 1440 of moving the right arm 1411 to the lower part of the head portion.

Accordingly, the second electronic device 101-2 may generate synthesized data 1490 illustrated in FIG. 14C. The synthesized data 1490 includes voice data 1492 and motion data 1493 for each driving time point 1491. The second electronic device 101-2 may add additional motion data 1494 corresponding to a motion attribute of the originator to the existing motion data 1493.

FIG. 15 is a flowchart illustrating a control method of an electronic device, according to an embodiment of the present disclosure.

In step 1510, the electronic device 101 senses a motion of a first user. As described above, the electronic device 101 may sense the motion of the first user on the basis of a result of analyzing multiple images or data from the motion sensor.

In step 1520, the electronic device 101 analyzes the sensed motion of the first user, and generates motion data on the basis of a result of the analysis. For example, the electronic device 101 may generate motion data by generating driving information of a motor in response to the motion of the first user.

In step 1530, the electronic device 101 may identify the first user. In step 1540, the electronic device 101 associates identification information of the first user with the generated motion data, and stores the identification information of the first user associated with the generated motion data. For example, as shown in Table 3, the electronic device 101 may associate identification information of the first user with the generated motion data, and may store the identification information of the first user associated with the generated motion data. The electronic device 101 may transmit, to another electronic device, the stored identification information associated with the generated motion data.

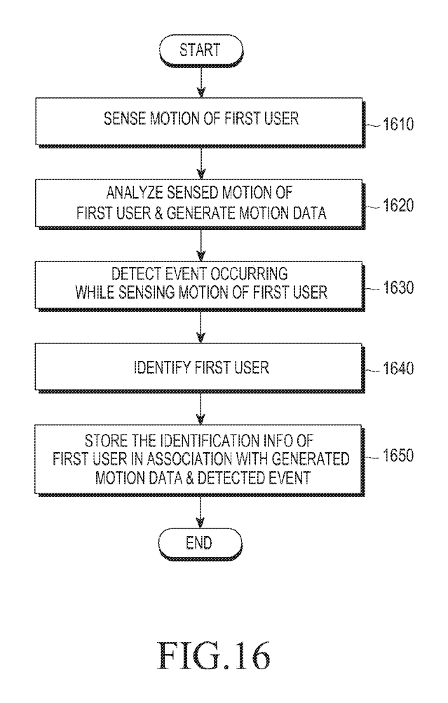

FIG. 16 is flowchart illustrating a control method of an electronic device, according to an embodiment of the present disclosure.

In step 1610, the electronic device 101 senses a motion of a first user. In step 1620, the electronic device 101 analyzes the sensed motion of the first user, and generates motion data on the basis of a result of the analysis.

In step 1630, the electronic device 101 detects an event occurring while sensing the motion of the first user. While the electronic device 101 senses the motion of the first user, the electronic device 101 may detect an event detected through hardware included in the electronic device 101 or an event received from another electronic device. For example, the electronic device 101 may detect a voice saying “uh˜” through a microphone while sensing a user motion expressing that the first user touches the head with the right hand.

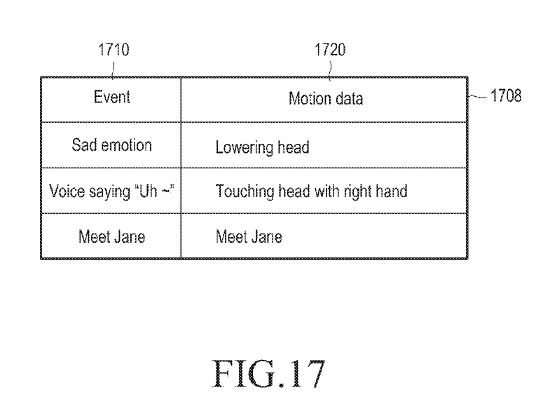

In step 1640, the electronic device 101 identifies the first user. In step 1650, the electronic device 101 associates identification information of the first user with the generated motion data and the detected event, and stores the identification information of the first user associated with the generated motion data and the detected event. For example, as illustrated in FIG. 17, the electronic device 101 stores association information 1708, which is obtained by associating an event 1710 with motion data 1720, for each user. For example, while the electronic device 101 senses the user motion, the electronic device 101 may detect a sad emotion of the user through the analysis of a voice of the user or through the analysis of a biometric signal of the user. Accordingly, the electronic device 101 may associate the sad emotion of the user with motion data expressing a motion of lowering the head, and may store the sad emotion of the user associated with motion data expressing the motion of lowering the head. Also, the electronic device 101 may detect an event indicating that the user is with a person who is identified as Jane, while the electronic device 101 senses a motion expressing that the user puts the hand over the mouth. As illustrated in FIG. 17, there is no limit to the type of an event that the electronic device 101 stores in association with motion data, and the electronic device 101 may associate multiple events with one motion datum and may store the multiple events associated with one motion datum.

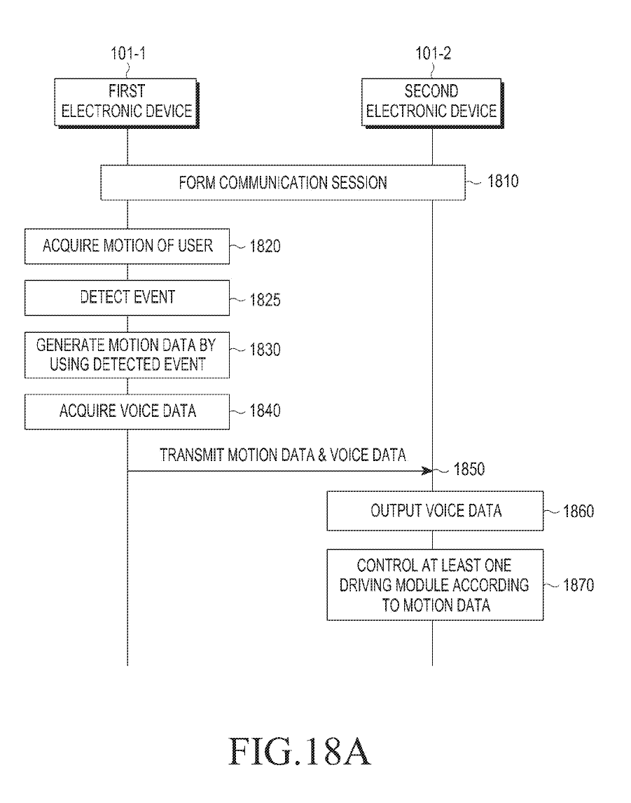

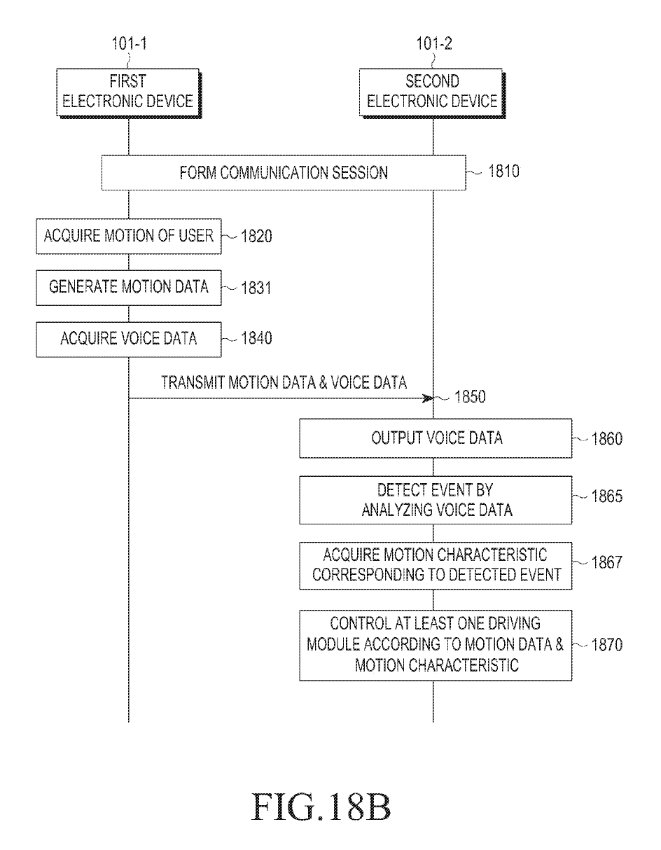

FIGS. 18A and 18B are signal flow diagrams illustrating an operation of an electronic device, according to an embodiment of the present disclosure.

Referring to FIG. 18A, in step 1810, the first electronic device 101-1 forms a communication session with the second electronic device 101-2. In step 1820, the first electronic device 101-1 acquires a motion of a user. In step 1825, the first electronic device 101-1 detects an event. In step 1830, the first electronic device 101-1 generates motion data by using the detected event and the motion of the user. For example, the first electronic device 101-1 may generate first motion data by using the motion of the user, and additionally, may finally generate motion data by reflecting second motion data, which corresponds to the detected event, in the first motion data. In step 1840, the first electronic device 101-1 acquires voice data. In step 1850, the first electronic device 101-1 transmits the motion data and the voice data to the second electronic device 101-2. The first electronic device 101-1 may transmit synthesized data, which is obtained by synthesizing the motion data and the voice data, to the second electronic device 101-2. In step 1860, the second electronic device 101-2 outputs the voice data. In step 1870, the second electronic device 101-2 drives at least one driving module (e.g., a motor) according to the motion data. For example, the first electronic device 101-1 may detect a voice saying “uh˜” from the user, and may transmit motion data, which is obtained by reflecting motion data expressing a motion of touching the head with the right hand in response to the voice saying “uh˜,” to the second electronic device 101-2. In response, the second electronic device 101-2 may drive the motor so as to move the right hand of the second electronic device 101-2 to the side of the head portion at a time point of outputting the voice data expressing “uh˜.”

Referring to FIG. 18B, in step 1810, the first electronic device 101-1 may form a communication session with the second electronic device 101-2. In step 1820, the first electronic device 101-1 acquires a motion of a user. In step 1831, the first electronic device 101-1 generates motion data by using the motion of the user. In step 1840, the first electronic device 101-1 acquires voice data. In step 1850, the first electronic device 101-1 transmits the motion data and the voice data to the second electronic device 101-2. The first electronic device 101-1 may transmit synthesized data, which is obtained by synthesizing the motion data and the voice data, to the second electronic device 101-2. In step 1860, the second electronic device 101-2 may output the voice data. In step 1865, the second electronic device 101-2 detects an event by analyzing the voice data. For example, the second electronic device 101-2 may detect a voice saying “uh˜” from the received voice data. In step 1867, the second electronic device 101-2 acquires a motion characteristic corresponding to the detected event. For example, the second electronic device 101-2 may pre-store the association information illustrated in FIG. 17, and may acquire a motion characteristic of the motion of touching the head with the right hand in response to the voice saying “uh˜” by using the association information.

In step 1870, the second electronic device 101-2 drives at least one driving module (e.g., a motor) according to the motion data and the motion characteristic.

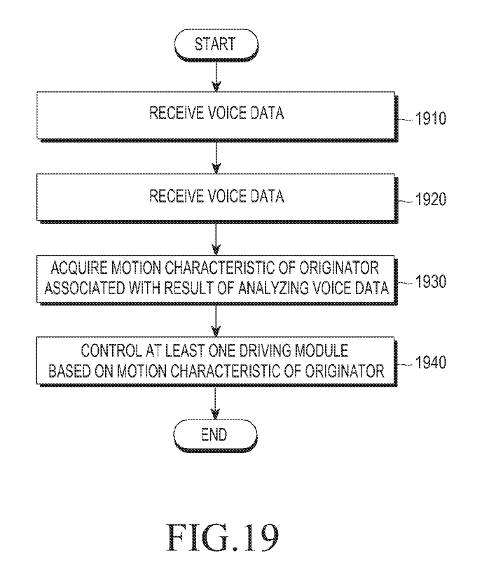

FIG. 19 is a flowchart illustrating a control method of an electronic device, according to an embodiment of the present disclosure.

In step 1910, the electronic device 101 receives voice data. In contrast with the above-described embodiments of the present disclosure, the electronic device 101 may receive, from another electronic device, only voice data, and not motion data.

In step 1920, the electronic device 101 analyzes the voice data. The electronic device 101, for example, may identify a voice saying “uh˜” from the voice data.

In step 1930, the electronic device 101 acquires a motion characteristic of an originator, which is associated with a result of analyzing the voice data. For example, the electronic device 101 may pre-store the association information illustrated in FIG. 17, and may acquire a motion characteristic of the motion of touching the head with the right hand, which is associated with the voice saying “uh˜,” by using the association information.

In step 1940, the electronic device 101 drives at least one driving module (e.g., a motor) in response to the motion characteristic of the originator. For example, the electronic device 101 may drive the motor so as to implement the motion characteristic of the motion of touching the head with the right hand which is associated with the voice saying “uh˜”.

In various embodiments of the present disclosure, a control method of an electronic device may include acquiring voice data representing an external voice; sensing a motion of a user; and generating motion data corresponding to the sensed motion of the user, synchronizing the voice data with the motion data in terms of time, and transmitting the synchronized voice data and the synchronized motion data, i.e. synchronized voice and motion data to another electronic device.

In various embodiments of the present disclosure, the control method of the electronic device may further include generating synthesized data obtained by synthesizing the voice data and the motion data according to a preset protocol; and transmitting the synthesized data to the another electronic device.

In various embodiments of the present disclosure, the motion data may include information for driving at least one motor included in the another electronic device. In various embodiments of the present disclosure, the motion data may include at least one of motor identification information, a driving time point, a driving direction, a driving degree, and a driving speed.

In various embodiments of the present disclosure, the motion data may include a parameter corresponding to at least one of motor identification information, a driving time point, a driving direction, a driving degree, and a driving speed, and the another electronic device may drive the at least one motor included in the another electronic device by using the at least one of the motor identification information, the driving time point, the driving direction, the driving degree, and the driving speed which corresponds to the parameter.

In various embodiments of the present disclosure, the control method of the electronic device may further include acquiring capability information of the another electronic device; and generating the motion data based on the capability information.

In various embodiments of the present disclosure, the capability information may include at least one of physical information, a growth model, and a relationship model of the another electronic device.

In various embodiments of the present disclosure, the control method of the electronic device may further include receiving a signal corresponding to selection of whether an image call is performed or whether a motion call is performed; when the image call is selected, synchronizing an acquired image with the voice data in terms of time, and transmitting the synchronized acquired image and the synchronized voice data to the another electronic device; and when the motion call is selected, synchronizing the motion data with the voice data in terms of time, and transmitting the synchronized motion data and the synchronized voice data, i.e. synchronized voice and motion data to the another electronic device.

In various embodiments of the present disclosure, the control method of the electronic device may further include acquiring motion data and voice data of the another electronic device from the another electronic device; driving at least one motor of the electronic device based on the motion data of the another electronic device; and outputting the voice data of the another electronic device through a speaker of the electronic device.

In various embodiments of the present disclosure, the control method of the electronic device may further include reading association information between an event and motion data corresponding to the event; and generating the motion data, which is obtained by reflecting the motion data corresponding to the event, when the event is detected.

In various embodiments of the present disclosure, the control method of the electronic device may further include reading association information between a user and motion data corresponding to the user; identifying the user; and generating the motion data which is obtained by reflecting the motion data corresponding to the identified user.

Each of the above-described elements of the electronic device may be configured with one or more components, and the names of the corresponding elements may vary based on the type of electronic device. The electronic device may include at least one of the above-described elements. Some elements may be omitted or additional elements may be included in the electronic device. Also, some of the hardware components may be combined into one entity, which may perform functions identical to those of the relevant components before the combination.

The term “module” as used herein, may refer to, for example, a unit including one of hardware, software, and firmware, or a combination of two or more of the hardware, software, and firmware. The “module” may be interchangeable with terms, such as “unit”, “logic”, “logical block”, “component”, and “circuit”. A module may be a minimum unit of an integrated component or a part thereof. A module may be a minimum unit for performing one or more functions or a part thereof. A module may be mechanically or electronically implemented. For example, a module may include at least one of an application-specific integrated circuit (ASIC) chip, a field-programmable gate array (FPGAs), and a programmable-logic device for performing certain operations which have been known or are to be developed hereafter.

According to embodiments of the present disclosure, at least part of a device (e.g., modules or functions thereof) or a method (e.g., operations) may be implemented by, for example, an instruction stored in a computer-readable storage medium provided in a form of a program module. When the command is executed by one or more processors (e.g., the processor 120), the one or more processors may perform a function corresponding to the command. The computer-readable storage medium may be, for example, the memory 130.

Examples of the computer-readable recording medium may include a hard disk, a floppy disk, magnetic media (e.g., a magnetic tape), optical media (e.g., a compact disc ROM (CD-ROM) and a digital versatile disc (DVD)), magneto-optical media (e.g., a floptical disk), a hardware device (e.g., a ROM, a RAM, and a flash memory), and the like. Also, examples of the program instructions may include a machine language code created by a compiler and a high-level language code executable by a computer by using an interpreter or the like. The above-described hardware device may be configured to operate as one or more software modules in order to perform the operations according to various embodiments of the present disclosure, and vice versa.

The module or program module according to various embodiments of the present disclosure may include one or more of the above-described elements, may further include other additional elements, or some of the above-described elements may be omitted therefrom. Operations executed by a module, a programming module, or other component elements, according to embodiments of the present disclosure, may be executed sequentially, in parallel, repeatedly, or in a heuristic manner. Further, some operations may be executed according to another order or may be omitted, or other operations may be added thereto.

According to embodiments of the present disclosure, in a storage medium that stores instructions, the instructions are configured to cause at least one processor to execute at least one operation when executed by the at least one processor, and the at least one operation may include: acquiring voice data representing an external voice; sensing a motion of a user; and generating motion data corresponding to the sensed motion of the user, synchronizing the voice data with the motion data in terms of time, and transmitting the synchronized voice data and the synchronized motion data, i.e. synchronized voice and motion data to another electronic device.

While the disclosure has been shown and described with reference to certain embodiments thereof, it will be understood by those skilled in the art that various changes in form and detail may be made therein without departing from the spirit and scope of the disclosure as defined by the appended claims.

What is claimed is:

1. An electronic device comprising:
a microphone receiving an external voice and processing the external voice into voice data;
a sensor sensing a motion of a user of the electronic device;
a communication module forming a communication session with another electronic device;
a processor that is electrically connected to the microphone, the communication module, and the sensor; and
a memory,
wherein the memory stores instructions that, when executed by the processor, cause the processor to generate motion data corresponding to the motion of the user, to synchronize the voice data with the motion data in terms of time, and to transmit the synchronized voice and motion data to the other electronic device through the communication session.

2. The electronic device as claimed in claim 1, wherein the memory stores instructions that, when executed by the processor, cause the processor to generate synthesized data obtained by synthesizing the voice data and the motion data according to a preset protocol, and to transmit the synthesized data to the other electronic device through the communication session.

3. The electronic device as claimed in claim 1, wherein the motion data comprises information for driving at least one motor included in the other electronic device.

4. The electronic device as claimed in claim 3, wherein the motion data comprises at least one of:
motor identification information;
a driving time point;
a driving direction;
a driving degree; and
a driving speed.

5. The electronic device as claimed in claim 3, wherein the motion data comprises a parameter corresponding to at least one of motor identification information, a driving time point, a driving direction, a driving degree, and a driving speed, and the other electronic device drives the at least one motor by using the at least one of the motor identification information, the driving time point, the driving direction, the driving degree, and the driving speed that corresponds to the parameter.

6. The electronic device as claimed in claim 1, wherein the memory stores instructions that, when executed by the processor, cause the processor to acquire capability information of the other electronic device, and to generate the motion data based on the capability information.

7. The electronic device as claimed in claim 6, wherein the capability information comprises at least one of physical information, a growth model, and a relationship model of the other electronic device.

8. The electronic device as claimed in claim 1, further comprising a camera,
wherein the memory stores instructions that, when executed by the processor, cause the processor to:
receive a signal corresponding to a selection of an image call or a motion call;
when the image call is selected, to synchronize an image, which is output from the camera, with the voice data in terms of time, and to transmit the synchronized image and voice data to the other electronic device; and
when the motion call is selected, to synchronize the motion data with the voice data in terms of time, and to transmit the synchronized motion and voice data to the other electronic device.

9. The electronic device as claimed in claim 1, further comprising:
at least one motor; and
a speaker,
wherein the memory stores instructions that, when executed by the processor, cause the processor to acquire motion data and voice data of the other electronic device from the other electronic device, to drive the at least one motor based on the motion data of the other electronic device, and to output the voice data of the other electronic device through the speaker.

10. The electronic device as claimed in claim 1, wherein the memory stores association information between an event and motion data corresponding to the event, and stores an instruction that, when executed by the processor, causes the processor to generate the motion data, which is obtained by reflecting the motion data corresponding to the event, if the processor detects the event.

11. The electronic device as claimed in claim 1, wherein the memory stores association information between a user and motion data corresponding to the user, and stores instructions that, when executed by the processor, cause the processor to identify the user, and to generate the motion data which is obtained by reflecting the motion data corresponding to the identified user.

12. A control method of an electronic device, the control method comprising:
acquiring voice data representing an external voice;
sensing a motion of a user of the electronic device;
generating motion data corresponding to the motion of the user;
synchronizing the voice data with the motion data in terms of time; and
transmitting the synchronized voice and motion data to another electronic device.

13. The control method as claimed in claim 12, further comprising:
generating synthesized data obtained by synthesizing the voice data and the motion data according to a preset protocol; and
transmitting the synthesized data to the other electronic device.

14. The control method as claimed in claim 12, wherein the motion data comprises information for driving at least one motor included in the other electronic device.

15. The control method as claimed in claim 14, wherein the motion data comprises at least one of:
motor identification information;
a driving time point;
a driving direction;
a driving degree; and
a driving speed.

16. The control method as claimed in claim 14, wherein the motion data comprises a parameter corresponding to at least one of motor identification information, a driving time point, a driving direction, a driving degree, and a driving speed, and the other electronic device drives the at least one motor by using the at least one of the motor identification information, the driving time point, the driving direction, the driving degree, and the driving speed that corresponds to the parameter.

17. The control method as claimed in claim 12, further comprising:
acquiring capability information of the other electronic device; and
generating the motion data based on the capability information.

18. The control method as claimed in claim 17, wherein the capability information comprises at least one of physical information, a growth model, and a relationship model of the other electronic device.

19. The control method as claimed in claim 12, further comprising:
receiving a signal corresponding to a selection of an image call or a motion call;
when the image call is selected, synchronizing an acquired image with the voice data in terms of time, and transmitting the synchronized acquired image and voice data to the other electronic device; and
when the motion call is selected, synchronizing the motion data with the voice data in terms of time, and transmitting the synchronized motion and voice data to the other electronic device.

20. The control method as claimed in claim 12, further comprising:
acquiring motion data and voice data of the other electronic device from the another electronic device;
driving at least one motor of the electronic device based on the motion data of the other electronic device; and
outputting the voice data of the other electronic device through a speaker of the electronic device.
